(19) United States
(12) Patent Application Publication
(10) Pub. No.: US 2023/0230494 A1
(43) Pub. Date: Jul. 20, 2023

(54) Information Processing Method and Information Processing System

(71) Applicant: Yamaha Corporation, Hamamatsu-shi (JP)

(72) Inventors: Rie ITO, Tokyo (JP); Yukako HIOKI, Hamamatsu-shi (JP); Takamitsu AOKI, Hamamatsu-shi (JP); Shinya KOSEKI, Fukuroi-shi (JP); Motoichi TAMURA, Hamamatsu-shi (JP)

(21) Appl. No.: 18/127,754

(22) Filed: Mar. 29, 2023

Related U.S. Application Data
(63) Continuation of application No. PCT/JP2021/032458, filed on Sep. 3, 2021.

(30) Foreign Application Priority Data
Sep. 30, 2020 (JP) 2020-164977

(51) Int. Cl. G09B 15/00; G10H 1/00

(52) U.S. Cl. CPC G09B 15/00; G10H 1/0016; G10H 2220/441

(57) ABSTRACT

A computer-implemented information processing method includes: determining, based on musical instrument information indicative of a musical instrument, a target part of a body of a first player, the first player playing the musical instrument indicated by the musical instrument information; and acquiring image information indicative of imagery of the determined target part.

### CROSS REFERENCE TO RELATED APPLICATIONS

This application is a Continuation Application of PCT Application No. PCT/JP2021/032458, filed on Sep. 3, 2021, and is based on, and claims priority from, Japanese Patent Application No. 2020-164977, filed on Sep. 30, 2020, the entire contents of which are incorporated herein by reference.

### FIELD

This disclosure relates to an information processing method and to an information processing system.

### BACKGROUND

Japanese Patent Application Laid-Open Publication No. H10-63175 discloses a performance evaluation apparatus that automatically evaluates playing of a musical instrument. When a lesson for playing of a musical instrument is provided using imagery, it is important to identify requisite imagery of a player of the musical instrument for use in the lesson.

### SUMMARY

An object of one aspect of this disclosure is to provide a technique for identifying imagery of a player of a musical instrument, the imagery being required for use in a lesson.

In one aspect, a computer-implemented information processing method includes: determining, based on musical instrument information indicative of a musical instrument, a target part of a body of a player, the player playing the musical instrument indicated by the musical instrument information; and acquiring image information indicative of imagery of the determined target part.

In another aspect, a computer-implemented information processing method includes: determining, based on sound information indicative of sounds emitted from a musical instrument, a target part of a body of a player, the player playing the musical instrument; and acquiring image information indicative of imagery of the determined target part.

In yet another aspect, an information processing system includes: at least one memory configured to store instructions; and at least one processor configured to implement the instructions to: determine, based on musical instrument information indicative of a musical instrument, a target part of a body of a player, the player playing the musical instrument indicated by the musical instrument information; and acquire image information indicative of imagery of the determined target part.

In yet another aspect, an information processing system includes: at least one memory configured to store instructions; and at least one processor configured to implement the instructions to: determine, based on sound information indicative of sounds emitted from a musical instrument, a target part of a body of a player, the player playing the musical instrument; and acquire image information indicative of imagery of the determined target part.

### BRIEF DESCRIPTION OF THE DRAWINGS

FIG. 1 is a diagram showing an example of an information providing system 1.

FIG. 2 is a diagram showing an example of a student learning system 100.

FIG. 3 is a diagram showing an example of an association table Ta.

FIG. 4 is a diagram showing an operation of the student learning system 100.

FIG. 5 is a diagram showing a student image G3.

FIG. 6 is a diagram showing the operation of the student learning system 100.

FIG. 7 is a diagram showing an example of an association table Ta1.

FIG. 8 is a diagram showing a student learning system 101.

FIG. 9 is a diagram showing an operation of cropping imagery of a part of a body of a player.

FIG. 10 is a diagram showing a student learning system 102.

FIG. 11 is a diagram showing an example of tablature.

FIG. 12 is a diagram showing an example of a guitar chord chart.

FIG. 13 is a diagram showing an example of a drum score.

FIG. 14 is a diagram showing an example of a score for a duet.

FIG. 15 is a diagram showing an example of a musical notation indicative of simultaneous production of plural sounds.

FIG. 16 is a diagram showing an example of a schedule indicated by schedule information.

FIG. 17 is a diagram showing another example of the schedule indicated by the schedule information.

FIG. 18 is a diagram showing a student learning system 103.

FIG. 19 is a diagram showing a student learning system 104.

FIG. 20 is a diagram showing an example of a user interface.

FIG. 21 is a diagram showing a student learning system 105.

FIG. 22 is a diagram showing an example of a training processor 191.

FIG. 23 is a diagram showing an example of training processing.

FIG. 24 is a diagram showing another example of a processor 180.

### DETAILED DESCRIPTION OF THE EMBODIMENTS

### A: First Embodiment

### A1: Information Providing System 1

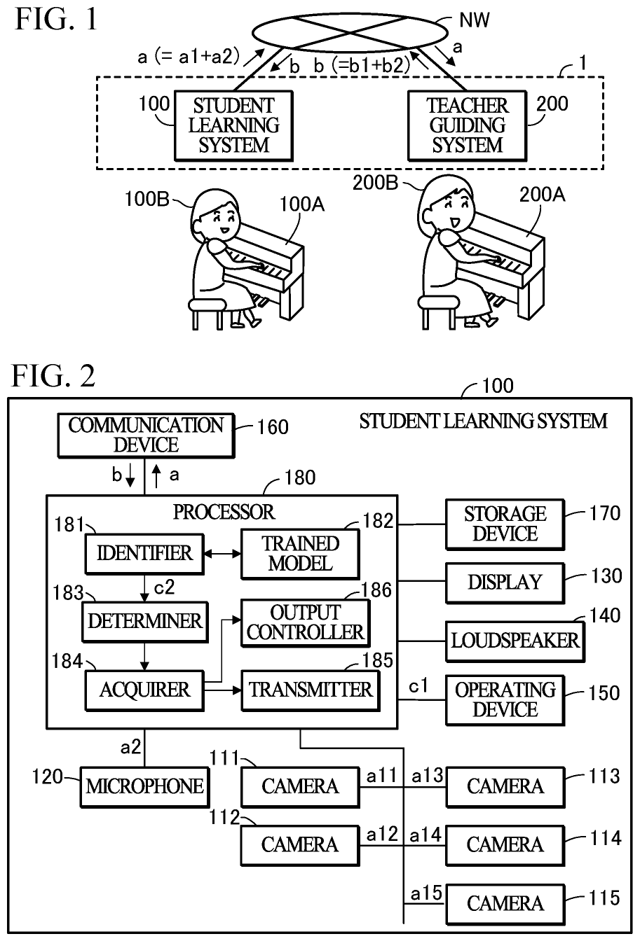

FIG. 1 is a diagram showing an information providing system 1 according to this disclosure. The information providing system 1 is an example of an information processing system. The information providing system 1 includes a student learning system 100 and a teacher guiding system 200. The student learning system 100 and the teacher guiding system 200 are able to communicate with each other via a network NW. A configuration of the teacher guiding system 200 is the same as that of the student learning system 100.

The student learning system 100 is used by a student 100B. The student 100B learns how to play a piece of music on a musical instrument 100A. The student learning system 100 is located in a room for students provided in a music school. Alternatively, the student learning system 100 may be located in a place different from the room for students provided in the music school. For example, the student learning system 100 may be located in a house of the student 100B.

The musical instrument 100A is a piano or a flute. Each is a musical instrument, and each is an example of a type of musical instrument. In the following, “type of musical instrument” may simply read as “musical instrument.” The student 100B is an example of a player. The musical instrument 100A is played by the student 100B at a predetermined position within the room in which the student learning system 100 is located. Thus, the student 100B playing the musical instrument 100A, the student 100B immediately before playing the musical instrument 100A, and the student 100B immediately after playing the musical instrument 100A can be captured by a fixed camera.

The teacher guiding system 200 is used by a teacher 200B. Using a musical instrument 200A, the teacher 200B teaches how to play a piece of music. The type of musical instrument 200A is the same as the type of musical instrument 100A. For example, if the musical instrument 100A is a piano, the musical instrument 200A is a piano. The teacher guiding system 200 is located in a room for teachers provided in the music school. Alternatively, the teacher guiding system 200 may be located in a place different from the room for teachers provided in the music school. For example, the teacher guiding system 200 may be located in a house of the teacher 200B.

The teacher 200B is an example of a player. The musical instrument 200A is played by the teacher 200B at a predetermined position within the room in which the teacher guiding system 200 is located. Thus, the teacher 200B playing the musical instrument 200A, the teacher 200B immediately before playing the musical instrument 200A, and the teacher 200B immediately after playing the musical instrument 200A can be captured by a fixed camera.

The student learning system 100 transmits student-play information a to the teacher guiding system 200. The student-play information a indicates a state in which the student 100B plays the musical instrument 100A. The student-play information a includes student-image information a1 and student-sound information a2.

The student-image information a1 indicates imagery (hereinafter referred to as a “student image”) representative of a state in which the student 100B plays the musical instrument 100A. The student-sound information a2 indicates sounds (hereinafter referred to as “student-play sounds”) emitted from the musical instrument 100A in a state in which the student 100B plays the musical instrument 100A.

The teacher guiding system 200 receives the student-play information a from the student learning system 100. The student-play information a includes the student-image information a1 and the student-sound information a2. The teacher guiding system 200 displays the student image based on the student-image information a1. The teacher guiding system 200 outputs the student-play sounds based on the student-sound information a2.

The teacher guiding system 200 transmits teacher-play information b to the student learning system 100. The teacher-play information b indicates a state in which the teacher 200B plays the musical instrument 200A. The teacher-play information b includes teacher-image information b1 and teacher-sound information b2.

The teacher-image information b1 indicates imagery (hereinafter referred to as a “teacher image”) representative of a state in which the teacher 200B plays the musical instrument 200A. The teacher-sound information b2 indicates sounds of a piece of music (hereinafter referred to as “teacher-play sounds”) emitted from the musical instrument 200A in a state in which the teacher 200B plays the musical instrument 200A.

The student learning system 100 receives the teacher-play information b from the teacher guiding system 200. The teacher-play information b includes the teacher-image information b1 and the teacher-sound information b2. The student learning system 100 displays the teacher image based on the teacher-image information b1. The student learning system 100 emits the teacher-play sounds based on the teacher-sound information b2.

### A2: Student Learning System 100

FIG. 2 is a diagram showing an example of the student learning system 100. The student learning system 100 includes cameras 111 to 115, a microphone 120, a display 130, a loudspeaker 140, an operating device 150, a communication device 160, a storage device 170, and a processor 180.

Each of the cameras 111 to 115 includes an image sensor. The image sensor is configured to convert light into an electrical signal. The image sensor is, for example, a charge coupled device (CCD) image sensor or a complementary metal oxide semiconductor (CMOS) image sensor.

The camera 111 generates student-finger information a11 by capturing fingers of the student 100B during playing of the musical instrument 100A. The student-finger information a11 indicates imagery in which the musical instrument 100A and fingers of the student 100B during playing of the musical instrument 100A are represented.

The camera 112 generates student-feet information a12 by capturing the feet of the student 100B during playing of the musical instrument 100A. The student-feet information a12 indicates imagery in which the musical instrument 100A and the feet of the student 100B during playing of the musical instrument 100A are represented.

The camera 113 generates student-whole-body information a13 by capturing the whole body of the student 100B during playing of the musical instrument 100A. The student-whole-body information a13 indicates imagery in which the musical instrument 100A and the whole body of the student 100B during playing of the musical instrument 100A are represented.

The camera 114 generates student-mouth information a14 by capturing the mouth of the student 100B during playing of the musical instrument 100A. The student-mouth information a14 indicates imagery in which the musical instrument 100A and the mouth of the student 100B during playing of the musical instrument 100A are represented.

The camera 115 generates student-upper-body information a15 by capturing the upper body of the student 100B during playing of the musical instrument 100A. The student-upper-body information a15 indicates imagery in which the musical instrument 100A and the upper body of the student 100B during playing of the musical instrument 100A are represented.

The student-finger information a11, the student-feet information a12, the student-whole-body information a13, the student-mouth information a14, the student-upper-body information a15, or a combination thereof, is included in the student-image information a1. The orientation of each of the cameras 111 to 115 is adjustable. Each of the cameras 111 to 115 may be referred to as an image capture device.

The microphone 120 receives the student-play sounds, and based on the student-play sounds the microphone 120 generates the student-sound information a2. The microphone 120 may be referred to as a sound receiver.

The display 130 is a liquid crystal display. The display 130 is not limited to a liquid crystal display. The display 130 may be an organic light emitting diode (OLED) display, for example. The display 130 may be a touch panel. The display 130 displays various kinds of information. The display 130 displays the teacher image based on the teacher-image information b1, for example. The display 130 may display the student image based on the student-image information a1.

The loudspeaker 140 outputs various kinds of sounds. The loudspeaker 140 emits the teacher-play sounds based on the teacher-sound information b2, for example. The loudspeaker 140 may emit the student-play sounds based on the student-sound information a2.

The operating device 150 may be a touch panel, but not limited to a touch panel. The operating device 150 may include various operation buttons, for example. The operating device 150 receives various kinds of information from a user such as the student 100B. The operating device 150 receives student-musical-instrument information c1 from the user, for example. The student-musical-instrument information c1 indicates the type of musical instrument 100A. The student-musical-instrument information c1 is an example of first musical instrument information indicative of a type of musical instrument.

The communication device 160 communicates with the teacher guiding system 200 via the network NW either by wire or wirelessly. The communication device 160 may communicate with the teacher guiding system 200 either by wire or wirelessly, but not via the network NW. The communication device 160 transmits the student-play information a to the teacher guiding system 200. The communication device 160 receives the teacher-play information b from the teacher guiding system 200.

The storage device 170 is a recording medium readable by a computer (for example, a non-transitory recording medium readable by a computer). The storage device 170 includes one or more memories. The storage device 170 includes a nonvolatile memory and a volatile memory, for example. The nonvolatile memory includes a read only memory (ROM), an erasable programmable read only memory (EPROM), and an electrically erasable programmable read only memory (EEPROM), for example. The volatile memory includes a random access memory (RAM), for example.

The storage device 170 stores a processing program, an arithmetic program, and various kinds of data. The processing program defines an operation of the student learning system 100. The arithmetic program defines an operation for identifying output Y1 from input X1.

The storage device 170 may store a processing program and an arithmetic program that are read from a storage device in a server (not shown). In this case, the storage device in the server is an example of a recording medium that is readable by a computer (for example, a non-transitory recording medium readable by a computer). The various kinds of data include multiple variables K1 described below.

The processor 180 includes one or more central processing units (CPUs). The one or more CPUs are included in examples of one or more processors. The processor and the CPU are each examples of a computer. One, some, or all of the functions of the processor 180 may be realized by circuitry, such as a digital signal processor (DSP), an application specific integrated circuit (ASIC), a programmable logic device (PLD), a field programmable gate array (FPGA), etc.

The processor 180 reads the processing program and the arithmetic program from the storage device 170. The processor 180 executes the processing program to function as an identifier 181, a determiner 183, an acquirer 184, a transmitter 185, and an output controller 186. The processor 180 functions as a trained model 182 by using the multiple variables K1 while executing the arithmetic program. The processor 180 is an example of an information processing apparatus.

The identifier 181 uses the student-sound information a2 to identify student-musical-instrument information c2. The student-musical-instrument information c2 indicates the type of musical instrument 100A. The student-musical-instrument information c2 is an example of the first musical instrument information indicative of a type of musical instrument. The first musical instrument information indicative of the type of musical instrument (for example, a piano) is an example of second musical instrument information indicative of a musical instrument (for example, a piano). The second musical instrument information is an example of musical instrument information. The student-sound information a2 is an example of first related information related to the type of musical instrument. The first related information related to the type of musical instrument (for example, a piano) is an example of related information related to a musical instrument (for example, a piano). The second related information is an example of related information. When the student-sound information a2 indicates sounds of a piano, the identifier 181 identifies the student-musical-instrument information c2, which indicates a piano as the type of musical instrument 100A. The identifier 181 identifies the student-musical-instrument information c2 by using the trained model 182, for example.

The trained model 182 includes a neural network. For example, the trained model 182 includes a deep neural network (DNN). The trained model 182 may include a convolutional neural network (CNN), for example. The deep neural network and the convolutional neural network are each an example of a neural network. The trained model 182 may include a combination of multiple types of neural network. The trained model 182 may include additional elements such as a self-attention mechanism. The trained model 182 may include a hidden Markov model (HMM) or a support vector machine (SVM), and not include a neural network.

The trained model 182 has been trained to learn a relationship between first information and second information. The first information is information related to a type of musical instrument. The second information is information indicative of the type of musical instrument relevant to the first information. The first information is an example of training-related information related to a musical instrument. The second information is an example of training-musical-instrument information indicative of a musical instrument specified from the training-related information. The trained model 182 uses, as the first information, output-sound information indicative of sounds emitted from the musical instrument 100A. The trained model 182 uses, as the second information, type information indicative of a type. The type includes a musical instrument that emits the sounds indicated by the output-sound information. The trained model 182 is an example of a first trained model.

The multiple variables K1, which are used to realize the trained model 182, are defined by machine learning using multiple pieces of training data T1. The training data T1 includes a combination of training input data and training output data. The training data T1 includes the first information as the training input data. The training data T1 includes the second information as the training output data. An example of the training data T1 is a combination of the output-sound information (first information) and the type information (second information). The output-sound information (first information) is indicative of the sounds emitted from the musical instrument 100A. The type information (second information) is indicative of the type, which includes the musical instrument that emits the sounds indicated by the output-sound information.

The trained model 182 generates the output Y1 in accordance with the input X1. The trained model 182 uses, as the input X1, the “first related information related to the type of musical instrument (for example, the student-sound information a2).” The trained model 182 uses, as the output Y1, the “type information indicative of the type that includes the musical instrument that emits the sounds indicated by the related information.”

The multiple pieces of training data T1 may each include only the training input data (first information), and need not include the training output data (second information). In this case, the multiple variables K1 are defined by machine learning such that the multiple pieces of training data T1 are divided into multiple clusters based on a degree of similarity between the multiple pieces of training data T1. Then, for each of the clusters, one or more persons set an association in the trained model 182. The association is an association between the cluster and the second information appropriate for the cluster. The trained model 182 identifies a cluster corresponding to the input X1, and then the trained model 182 generates the second information corresponding to the identified cluster, as the output Y1.

The determiner 183 determines, based on the musical instrument information (student-musical-instrument information c1 or c2), a target part of a u body of a player (for example, student 100B). The player plays a musical instrument of the type indicated by the musical instrument information. The player, who plays the musical instrument of the type indicated by the musical instrument information, is an example of a player playing the musical instrument indicated by the musical instrument information. The target part is a part of a body. The part of the body is a target to be observed by a teacher of a musical instrument of the type indicated by the musical instrument information. The determiner 183 determines the target part by referring to an association table Ta. The association table Ta indicates associations between a type of musical instrument and a part of a body (target part). The target part is, for example, fingers of the student 100B, the feet of the student 100B, the whole body of the student 1008, the mouth of the student 100B, the upper body of the student 100B, or a combination thereof. The association table Ta is stored in the storage device 170.

The acquirer 184 acquires various kinds of information. For example, the acquirer 184 acquires image information indicative of imagery of the target part, the target part having been determined by the determiner 183. From among the student-finger information a11, the student-feet information a12, the student-whole-body information a13, the student-mouth information a14, and the student-upper-body information a15, the acquirer 184 acquires, as the target image information, information indicative of the imagery of the target part determined by the determiner 183. The target image information is an example of image information. The acquirer 184 generates the student-image information a1 by using the target image information. For example, the acquirer 184 generates the student-image information a1 that includes the target image information.

The transmitter 185 transmits the student-image information a1, which is generated by the acquirer 184, from the communication device 160 to the teacher guiding system 200. The teacher guiding system 200 is an example of a recipient. The recipient is an example of an external apparatus.

The output controller 186 controls the display 130 and the loudspeaker 140. For example, the output controller 186 causes the display 130 to display the teacher image based on the teacher-image information b1. In this case, first, the acquirer 184 acquires the teacher-image information b1 from the communication device 160. The acquirer 184 provides the output controller 186 with the teacher-image information b1. The output controller 186 causes the display 130 to display the teacher image using the teacher-image information b1.

The output controller 186 may cause the display 130 to display the student image based on the student-image information a1. In this case, the acquirer 184 provides the output controller 186 with the student-image information a1. The output controller 186 causes the display 130 to display the student image using the student-image information a1. In this case, even when the teacher 200B is absent, the student 100B can learn how to play the musical instrument 100A by viewing the student image (image of the target part) indicated by the student-image information a1. In addition, in a state in which the teacher guiding system 200 is absent but the student learning system 100 is present, the student 100B can learn how to play the musical instrument 100A by viewing the student image (imagery of the target part) indicated by the student-image information a1.

The output controller 186 may cause the display 130 to display the teacher image and the student image side-by-side based on the teacher-image information b1 and the student-image information a1. In this case, the acquirer 184 acquires each of the teacher-image information b and the student-image information a1 as described above. The acquirer 184 provides the output controller 186 with the teacher-image information b1 and the student-image information a1. The output controller 186 causes the display 130 to display the teacher image and the student image side-by-side based on the teacher-image information b1 and the student-image information a1.

The output controller 186 causes the loudspeaker 140 to emit the teacher-play sounds based on the teacher-sound information b2. In this case, first, the acquirer 184 acquires the teacher-sound information b2 from the communication device 160. The acquirer 184 provides the output controller 186 with the teacher-sound information b2. The output controller 186 causes the loudspeaker 140 to emit the teacher-play sounds using the teacher-sound information b2.

The output controller 186 may cause the loudspeaker 140 to emit the student-play sounds based on the student-sound information a2. In this case, first, the acquirer 184 acquires the student-sound information a2 from the microphone 120. The acquirer 184 provides the output controller 186 with the student-sound information a2. The output controller 186 causes the loudspeaker 140 to emit the student-play sounds using the student-sound information a2.

The output controller 186 may cause the loudspeaker 140 to emit the teacher-play sounds and the student-play sounds alternately based on the teacher-sound information b2 and the student-sound information a2. In this case, the acquirer 184 acquires each of the teacher-sound information b2 and the student-sound information a2 as described above. The acquirer 184 provides the output controller 186 with the teacher-sound information b2 and the student-sound information a2. The output controller 186 causes the loudspeaker 140 to emit the teacher-play sounds and the student-play sounds alternately based on the teacher-sound information b2 and the student-sound information a2.

### A3: Teacher Guiding System 200

The teacher guiding system 200 differs from the student learning system 100 in that the teacher guiding system 200 is used by the teacher 200B instead of the student 100B. The configuration of the teacher guiding system 200 is the same as that of the student learning system 100, as described above.

Explanation of the configuration of the teacher guiding system 200 is largely realized in the following description by replacing terms that appear in the description of the student learning system 100, as follows. The term “musical instrument 100A” is replaced with “musical instrument 200A.” The term “student 100B” is replaced with “teacher 200B.” The term “student-play information a” is replaced with “teacher-play information b.” The term “student-image information a1” is replaced with “teacher-image information b1.” The term “student-finger information a11” is replaced with “teacher-finger information b11.” The term “student-feet information a12” is replaced with “teacher-feet information b12.” The term “student-whole-body information a13” is replaced with “teacher-whole-body information b13.” The term “student-mouth information a14” is replaced with “teacher's mouth information b14.” The term “student-upper-body information a15” is replaced with “teacher-upper-body information b15.” The term “student-sound information a2” is replaced with “teacher-sound information b2.” The term “student-musical-instrument information c1, c2” is replaced with “teacher-musical-instrument information d1, d2.” The term “teacher-play information b” is replaced with “student-play information a.” The term “teacher-image information b1” is replaced with “student-image information a1.” The term “teacher-sound information b2” is replaced with “student-sound information a2.” Thus, detailed explanation of the configuration of the teacher guiding system 200 is omitted.

### A4: Association Table Ta

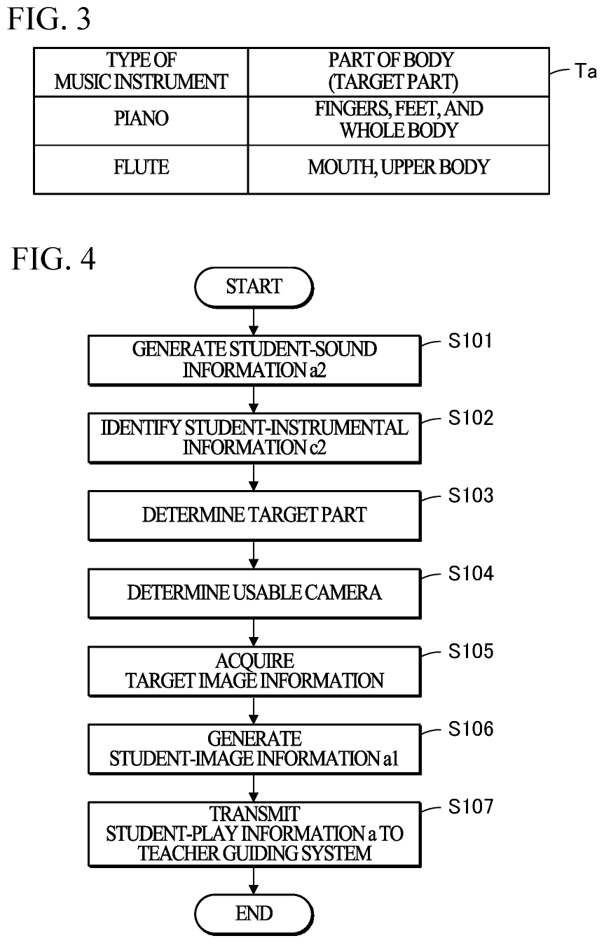

FIG. 3 is a diagram showing an example of an association table Ta. The association table Ta indicates associations between a type of musical instrument and a part of a body (target part). The column showing the type of musical instrument in the association table Ta indicates a type of musical instrument that is a target of a lesson. The association table Ta indicates “piano” and “flute” as types of musical instrument. The column showing the part of the body (target part) in the association table Ta indicates a part of a body of a player. An image of the part of the body of the player is required for a lesson for the musical instrument indicated in the column of the type of musical instrument.

In a piano lesson, a student faces a piano in a posture preferred by the student, and the student using his/her fingers presses and releases keys of the piano while operating with his/her feet pedals of the piano. To teach the student, a teacher focuses on fingers of the student, the feet of the student, and the whole body of the student (for example, the posture of the student). For example, the teacher focuses on fingers of the student to teach finger movements to play a passage of a piece of music. The teacher focuses on the feet of the student to teach pedal operation. The teacher focuses on a relationship between finger positions of the student relative to keys of the piano 2 to teach correct operation of the piano keys. The teacher focuses on the whole body of the student to teach student posture at different points in time when the student is playing the piano. The teacher teaches the student by showing his/her fingers to the student, his/her feet to the student, his/her whole body to the student (the posture of the teacher, etc.), or a combination thereof. Thus, in the association table Ta, the type of musical instrument “piano” is associated with parts of a body “fingers, feet, and whole body.”

In a flute lesson, a student positions a flute near his/her upper body, and blows into the flute by using his/her mouth while operating keys of the flute by using his/her fingers. To teach the student, the teacher focuses on the mouth of the student and the upper body of the student (for example, the posture of the student, an angle between the student and the flute, and finger movements of the student). For example, the teacher focuses on the mouth of the student to teach lip shapes at different points in time when the student is playing the flute. The teacher focuses on the upper body of the student to teach a relationship between the position of the student and the position of the flute. The teacher teaches the student by showing his/her mouth to the student, his/her upper body to the student, or a combination thereof. Thus, in the association table Ta, the type of musical instrument “flute” is associated with parts of a body “mouth and upper body.”

### A5: Operation of Student Learning System 100

FIG. 4 is a diagram showing an operation of the student learning system 100 to transmit the student-play information a. The storage device 170 stores capture target information indicative of targets for capture by the cameras 111 to 115.

The student 100B sounds the musical instrument 100A to cause the student learning system 100 to identify the type of musical instrument 100A. At step S101, the microphone 120 generates the student-sound information a2 based on sounds emitted from the musical instrument 100A.

At step S102, the identifier 181 uses the student-sound information a2 to identify the student-musical-instrument information c2, which indicates the type of musical instrument 100A.

At step S102, the identifier 181 first inputs the student-sound information a2 into the trained model 182. Then, the identifier 181 identifies, as the student-musical-instrument information c2, information output from the trained model 182 in response to the input of the student-sound information a2.

At step S103, the determiner 183 determines a target part of the body of the student 100B, based on the student-musical-instrument information c2.

At step S103, the determiner 183 refers to the association table Ta to determine, as the target part, the part of the body, which is associated with the type of musical instrument indicated by the student-musical-instrument information c2. For example, when the student-musical-instrument information c2 indicates a piano, the determiner 183 determines, as target parts of the student 100B, fingers of the student 100B, the feet of the student 100B, and the whole body of the student 100B.

When the operating device 150 receives the student-musical-instrument information c1, which indicates the type of musical instrument 100A, from a user such as the student 100B, the determiner 183 may determine the target part of the body of the student 100B based on the student-musical-instrument information c1 at step S103.

At step S104, the acquirer 184 determines a camera (hereinafter referred to as a “usable camera”), which is to be used to capture the student 100B, from among the cameras 111 to 115 based on the target part.

At step S104, the acquirer 184 refers to the capture target information, which indicates targets for capture by the cameras 111 to 115, to determine, as a usable camera(s), at least one camera that can capture the target part(s) from among the cameras 111 to 115.

At step S105, the acquirer 184 acquires, as the target image information, information generated by the usable camera(s).

At step S106, the acquirer 184 generates the student-image information at by using the target image information.

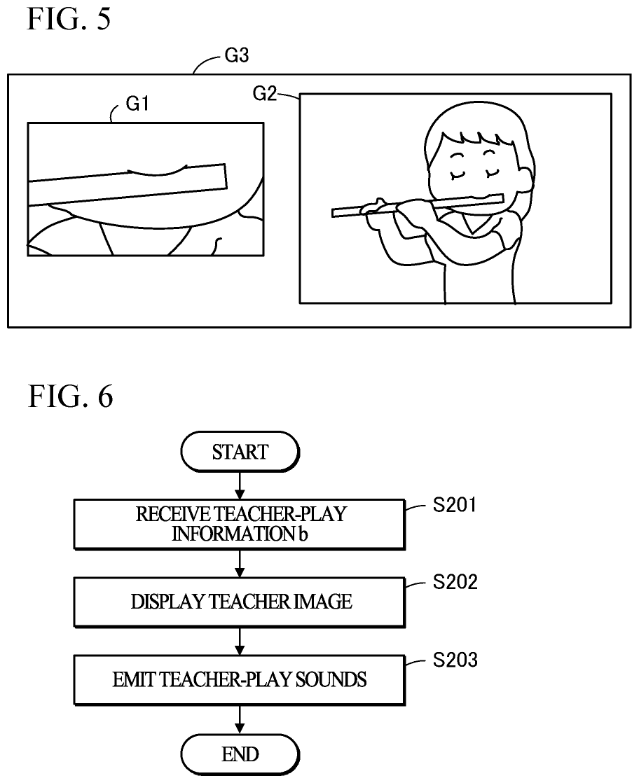

For example, when each of the cameras 114 and 115 is a usable camera, the acquirer 184 generates the student-image information a1 that includes the student-mouth information a14, which is generated by the camera 114, and the student-upper-body information a15, which is generated by the camera 115. FIG. 5 is a diagram showing a student image G3 indicated by the student-image information a1. The student image G3 includes an image G1 and an image G2. The image G1 is indicated by the student-mouth information a14. The image G2 is indicated by the student-upper-body information a15.

At step S107 in FIG. 4, the transmitter 185 transmits the student-play information a, which includes the student-image information a1 and the student-sound information a2, from the communication device 160 to the teacher guiding system 200.

The teacher guiding system 200 transmits the teacher-play information b to the student learning system 100 by operating in the same manner as the student learning system 100.

FIG. 6 is a diagram showing the operation of the student learning system 100 to output the teacher image and the teacher-play sounds based on the teacher-play information b.

At step S201, the communication device 160 receives the teacher-play information b. The teacher-play information b includes the teacher-image information b1 and the teacher-sound information b2.

At step S202, the output controller 186 displays the teacher image on the display 130 based on the teacher-image information b1.

At step S203, the output controller 186 emits the teacher-play sounds from the loudspeaker 140 based on the teacher-sound information b2. Note that step S203 may be executed before execution of step S202.

By operating in the same manner as the student learning system 100, the teacher guiding system 200 displays the student image based on the student-image information a1 while emitting the student-play sounds based on the u student-sound information a2.

According to this embodiment, it is possible to identify imagery of a player (student or teacher) required to teach how to play a musical instrument in accordance with a type of musical instrument (in accordance with a musical instrument). In addition, according to this embodiment, it is possible to transmit imagery of a player, which is required for a lesson, to a recipient. Accordingly, even when the teacher 200B is in a room different from a room in which the student 100B plays the musical instrument 100A, the teacher 200B can observe imagery of the student 100B required to teach how to play the musical instrument 100A. In addition, even when the student 100B is in a room different from a room in which the teacher 200B plays the musical instrument 200A, the student 100B can observe imagery of the teacher 200B playing the musical instrument 200A, which is a model of playing the musical instrument 200A.

The determiner 183 of the student learning system 100 may determine the target part by using the teacher-musical-instrument information d1 or d2 instead of by using the student-musical-instrument information c1 or c2. For example, the communication device 160 of the teacher guiding system 200 transmits the teacher-musical-instrument information d1 or d2 to the student learning system 100. The determiner 183 of the student learning system 100 obtains the teacher-musical-instrument information d1 or d2 via the communication device 160 of the student learning system 100. In this case, it is possible to omit the identifier 181 and the trained model 182 from the student learning system 100.

The determiner 183 of the teacher guiding system 200 may determine the target part by using the student-musical-instrument information c1 or c2 instead of by using the teacher-musical-instrument information d1 or d2. For example, the communication device 160 of the student learning system 100 transmits the student-musical-instrument information c1 or c2 to the teacher guiding system 200. The determiner 183 of the teacher guiding system 200 obtains the student-musical-instrument information c1 or c2 via the communication device 160 of the teacher guiding system 200. In this case, it is possible to omit the identifier 181 and the trained model 182 from the teacher guiding system 200.

### B: Modifications

The following are examples of modifications of the embodiment described above. Two or more modifications freely selected from the following modifications may be combined as long as no conflict arises from such a combination.

### B1: First Modification

In the embodiment described above, the types of musical instrument are not limited to a piano and a flute as long as the number of types of musical instruments is two or more. For example, the types of musical instrument may be two or more of a piano, a flute, an electone (registered trademark), a violin, a guitar, a saxophone, and drums. The piano, the flute, the electone, the violin, the guitar, the saxophone, and the drums are each an example of a musical instrument.

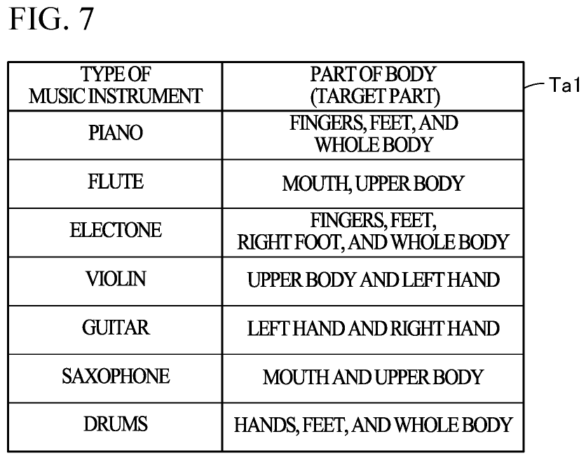

FIG. 7 is a diagram showing an example of an association table Ta1 used in a state in which the types of musical instrument include a piano, a flute, an electone, a violin, a guitar, a saxophone, and drums.

For example, in an electone lesson, a student operates an electone as follows: The student faces the electone in a posture preferred by the student. The student operates upper keys and lower keys of the electone using his/her fingers. The student operates pedal keys of the electone using his/her feet (toe, heel). The student operates an expression pedal of the electone using his/her right foot.

In an electone lesson, a teacher focuses on fingers of the student, on the feet (especially, the right foot) of the student, and on the whole body of the student (for example, the posture of the student) to teach the student. The teacher teaches the student by showing his/her fingers to the student, his/her feet (especially, his/her right foot) to the student, his/her whole body to the student (the posture of the teacher, etc.), or a combination thereof.

Thus, in the association table Ta1, the type of musical instrument, “electone” is associated with parts of a body “fingers, feet, right foot, and whole body.”

In a violin lesson, a student plays a violin as follows. The student supports the violin with his/her chin, shoulder, and left hand, and holds a bow of the violin with his/her right hand. The student presses strings of the violin with his/her left fingers. The student plays the violin while changing an angle between the violin and the student, an angle between the bow and the violin, and positions of his/her left fingers on the violin strings.

In a violin lesson, a teacher focuses on the upper body of the student (a relationship between the position of the student and the position of the violin) and the left hand of the student to teach the student. The teacher teaches the student by showing his/her upper body (a relationship between the position of the teacher and the position of the violin) to the student, his/her left hand to the student, or a combination thereof.

Thus, in the association table Ta1, the type of musical instrument “violin” is associated with parts of a body “upper body and left hand.”

In a guitar lesson, a student presses guitar strings of a guitar with his/her left hand while plucking the strings of the guitar with his/her right hand fingers. A teacher focuses on both the left hand of the student and the right hand of the student to teach the student. The teacher teaches the student by showing his/her left hand to the student, his/her right hand to the student, or a combination thereof.

Thus, in the association table Ta1, the type of musical instrument “guitar” is associated with parts of a body “left hand and right hand.”

In a saxophone lesson, a student positions a saxophone near his/her upper body, and places a reed of the saxophone in his/her mouth, and using fingers of his/her left and right hands operates keys and levers of the saxophone. A teacher focuses on the mouth of the student and the upper body of the student (for example, how to vibrate the reed of the saxophone, the position of the mouth of the student on a mouthpiece of the saxophone, the posture of the student, an angle between the student and the saxophone, and movements of the fingers of the student) to teach the student. The teacher teaches the student by showing his/her mouth to the student, his/her upper body to the student, or a combination thereof.

Thus, in the association table Ta1, the type of musical instrument “saxophone” is associated with parts of a body “mouth and upper body.”

In a drum lesson, a student play drums with his/her hands and feet. A teacher focuses on the hands and feet of the student and the whole body of the student to teach the student (for example, to teach timings of movements of the hands and feet of the student). The teacher teaches the student by showing movements of his/her hands and feet to the student and his/her whole body to the student.

Thus, in the association table Ta1, the type of musical instrument “drums” is associated with parts of a body “hands, feet, and whole body.”

The student learning system 100 and the teacher guiding system 200 each include a camera for capturing the parts of the body indicated in the association table Ta1.

According to the first modification, it is possible to change imagery of a player, which is required to teach how to play the musical instrument, in accordance with a type of musical instrument, for example an instrument other than a piano or a flute, and it is possible to transmit the imagery to a recipient.

### B2: Second Modification

In the embodiment and the first modification described above, the determiner 183 may determine the target part of the body of the player without using either the association tables Ta or Ta1. For example, the determiner 183 may determine the target part of the body of the player by using a trained model, which has been trained to learn a relationship between a type of musical instrument and a part of a body.

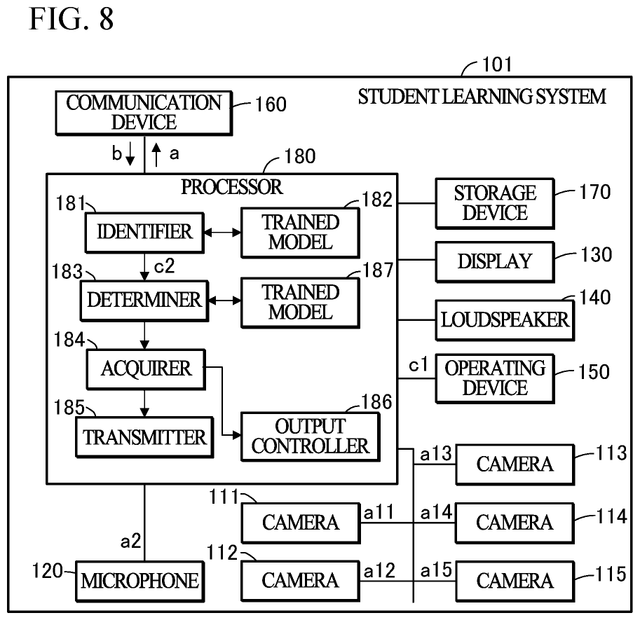

FIG. 8 is a diagram showing a student learning system 101. The student learning system 101 includes a trained model 187. The trained model 187 has been trained to learn the relationship between a type of musical instrument and a part of a body.

The trained model 187 includes a neural network. For example, the trained model 187 includes a deep neural network. The trained model 187 may include a convolutional neural network, for example. The trained model 187 may include a combination of multiple types of neural network. The trained model 187 may include additional elements such as a self-attention mechanism. The trained model 187 may include a hidden Markov model or a support vector machine, and not include a neural network.

The processor 180 functions as the trained model 187 based on a combination of an arithmetic program, which defines an operation for identifying output Y1 from input X1, and multiple variables K2. The multiple variables K2 are defined by machine learning using multiple pieces of training data T2. The training data T2 includes a combination of information, which indicates a type of musical instrument (training input data), and information, which indicates a part of a body (training output data). In the training data T2, the information, which indicates the type of musical instrument, indicates the types of musical instrument shown in FIG. 7, for example. In the training data T2, the information, which indicates the part of the body, indicates the parts of the body shown in FIG. 7, for example. In the training data T2, the combination of the information, which indicates the type of musical instrument, and the information, which indicates the part of the body, corresponds to a combination of the type of musical instrument and the part of the body shown in FIG. 7. Thus, in the training data T2, the information, which indicates the part of the body, indicates a part (target part) of a body of a first performer. The first performer is an example of a second player. The first performer plays a musical instrument that belongs to the type indicated by the training input data in the training data T2. The part (target part) of the body of the first performer is a target observed by a teacher of the musical instrument that belongs to the type indicated by the training input data in the training data T2.

The determiner 183 inputs the student-musical-instrument information c1 or c2 into the trained model 187. Then, the determiner 183 determines, as the target part of the body of the player, a part of a body indicated by information output from the trained model 187 in response to the input of the student-musical-instrument information c1 or c2.

The multiple pieces of training data T2 may include only the training input data and need not include the training output data. In this case, the multiple variables K2 are defined by machine learning such that the multiple pieces of training data T2 are divided into multiple clusters based on a degree of similarity between the multiple pieces of training data T2. Then, for each of the clusters, one or more persons set an association in the trained model 187. The association is an association between the cluster and information indicative of a part (target part) of a body appropriate for the cluster. The trained model 187 identifies a cluster corresponding to the input X1 and then the trained model 187 generates information corresponding to the identified cluster, as the output Y1.

According to the second modification, the determiner 183 can determine the part of the body of the player without using either of the association tables Ta and Ta1.

### B3: Third Modification

In the embodiment, the first modification, and the second modification described above, when the target part is a part of a body (for example, both feet), the acquirer 184 may acquire the image information, which indicates the target part, from whole-body-image information. The whole-body-image information indicates a whole body of a player.

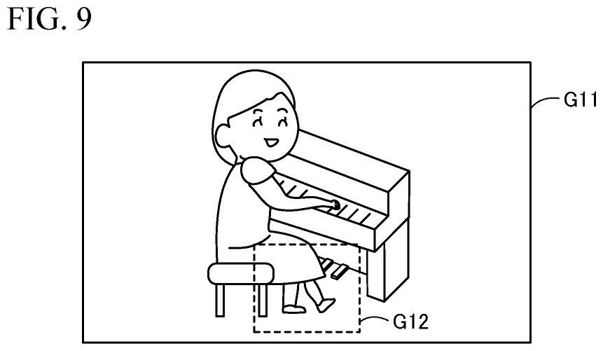

FIG. 9 is a diagram showing an example of a relationship between an image G11 and an image G12. The image G11 is indicated by the whole-body-image information. The image G12 indicates a part of the body of the player. The image G12 indicates, as the part of the body of the player, the feet of the player. The image G12 may indicate, as the part of the body of the player, a part of the body of the player different from the feet of the player.

The position of the image G12 on the image G11 is predetermined in pixels for each type of musical instrument. Accordingly, the position of the image G12 on the image G11 is changeable in accordance with the type of musical instrument. The acquirer 184 acquires, as image information indicative of the image G12, part of the whole-body-image information indicative of the image G11. The part of the whole-body-image information is predetermined in accordance with the type indicated by the student-musical-instrument information c1 or c2.

The position of the image G12 on the image G11 may not be predetermined for each type of musical instrument. For example, the acquirer 184 first identifies a part of the image G 1, which indicates the target part, by using an image recognition technique. Then, the acquirer 184 acquires part of the whole-body-image information, which indicates the target part, from the whole-body-image information.

For only a first musical instrument, the acquirer 184 may identify the position of the image G12 on the image G11 by using an image recognition technique. The relationship between the position of a player and the position of the first musical instrument is changeable. The first musical instrument is, for example, a flute, a violin, a guitar, or a saxophone. In this case, it is possible to readily acquire the image information indicative of the target part compared to a configuration in which the position of the image G12 on the image G11 is fixed.

For a second musical instrument, the acquirer 184 acquires, as the image information indicative of the image G12, the part of the whole-body-image information that is predetermined in accordance with the type indicated by the student-musical-instrument information c1 or c2. The second musical instrument has an almost unchangeable relationship between the position of a player and the position of the second musical instrument. The second musical instrument is, for example, a piano, an electone, or drums. In this case, the acquirer 184 can readily identify the position of the image G12 without using an image recognition technique.

According to the third modification, it is possible to reduce a number of cameras compared to a configuration in which multiple cameras are provided in one-to-one correspondence with multiple parts (target parts) of a body.

### B4: Fourth Modification

In the embodiment and the first to third modifications described above, the recipient of the teacher-play information b is not limited to the student learning system 100. The recipient of the teacher-play information b may be an electronic device used by a guardian of the student 100B (for example, a parent of the student 100B). The electronic device is, for example, a smartphone, a tablet, or a notebook personal computer. The recipient of the teacher-play information b may include both the student learning system 100 and the electronic device used by the guardian of the student 100B.

According to the fourth modification, a guardian of the student 100B can teach the student 100B while observing imagery of a teacher.

### B5: Fifth Modification

In the embodiment and the first to fourth modifications described above, each of the first related information related to the type of musical instrument and the second related information related to the musical instrument is not limited to the student-sound information a2. Each of the first related information and the second related information may be image information indicative of the musical instrument 100A (image information indicative of imagery of the musical instrument 100A).

In a configuration in which the image information indicative of the musical instrument 100A is used as the related information, the identifier 181 identifies the musical instrument information (student-musical-instrument information c2) by using a trained model. The trained model has been trained to learn a relationship between first image information and first type information. The first image information indicates imagery of a musical instrument 100A. The first type information indicates a type that includes the musical instrument represented by the imagery indicated by the first image information.

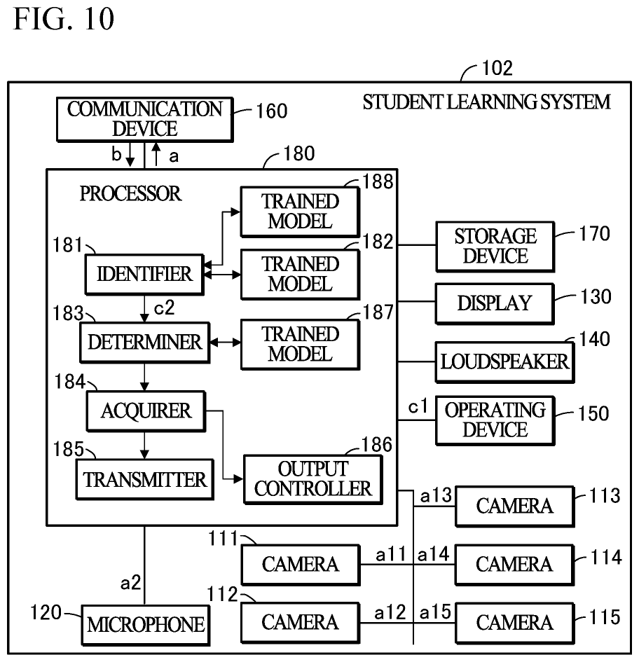

FIG. 10 is a diagram showing a student learning system 102 that includes a trained model 188. The trained model 188 has been trained to learn the relationship between the first image information and the first type information. The trained model 188 is an example of a first trained model.

The trained model 188 includes a neural network. For example, the trained model 188 includes a deep neural network. The trained model 188 may include a convolutional neural network, for example. The trained model 188 may include a combination of multiple types of neural network. The trained model 188 may include additional elements such as a self-attention mechanism. The trained model 188 may include a hidden Markov model or a support vector machine, and not include a neural network.

The processor 180 functions as the trained model 188 based on a combination of an arithmetic program, which defines an operation for identifying output Y1 from input X1, and multiple variables K3. The multiple variables K3 are defined by machine learning using multiple pieces of training data T3. The training data T3 includes a combination of information, which indicates imagery of the musical instrument 100A (training input data), and information, indicating a type that includes a musical instrument represented by the imagery indicated by the training input data (training output data).

The identifier 181 inputs the image information, which indicates the musical instrument 100A, into the trained model 188. Then, the identifier 181 identifies, as the student-musical-instrument information c2, information output from the trained model 188 in response to the input of the image information, which indicates the musical instrument 100A.

The multiple pieces of training data T3 may include only the training input data and need not include the training output data. In this case, the multiple variables K3 are defined by machine learning such that the multiple pieces of training data T3 are divided into multiple clusters based on a degree of similarity between the multiple pieces of training data T3. Then, for each of the clusters, one or more persons set an association in the trained model 188. The association is an association between the cluster and “information indicative of the type of musical instrument” appropriate for the cluster. The as trained model 188 identifies a cluster corresponding to the input X1, and then the trained model 182 generates information corresponding to the identified cluster, as the output Y1.

According to the fifth modification, it is possible to use the image information, which indicates the musical instrument 100A, as the related information indicative of the musical instrument.

### B6: Sixth Modification

In the fifth modification, the identifier 181 may use, as the image information indicative of the musical instrument 100A, information (hereinafter referred to as “camera image information”) generated by one of the cameras 111 to 115.

The camera image information may indicate not only the musical instrument 100A and the student 100B, but also a musical instrument of a type different from the type of musical instrument 100A. If camera image information, which indicates multiple types of musical instrument, is input into the trained model 188, the information output from the trained model 188 may not indicate the type of musical instrument 100A. Accordingly, the identifier 181 first extracts partial image information, which indicates only the musical instrument 100A, from the camera image information. Then, the identifier 181 inputs the partial image information into the trained model 188.

For example, the identifier 181 first identifies a person (student 100B) from imagery indicated by the camera image information. A person is more easily recognized than a musical instrument. Then, the identifier 181 identifies, as the musical instrument 100A, an object at a shortest distance from the person (student 100B) in the imagery indicated by the camera image information. Then, the identifier 181 extracts the partial image information, which indicates only the object identified as the musical instrument 100A, from the camera image information. Then, the identifier 181 inputs the partial image information into the trained model 188.

According to the sixth modification, it is possible to use the camera image information, which is generated by one of the cameras 111 to 115, as the first related information related to the type of musical instrument. Therefore, it is possible to use one of the cameras 111 to 115 as a device configured to generate the related information.

### B7: Seventh Modification

In the embodiment and the first to sixth modifications described above, the first related information related to the type of musical instrument may be musical-score information indicative of a musical score corresponding to a type of musical instrument. A musical score corresponding to a type of musical instrument (for example, a guitar) is an example of a musical score corresponding to a musical instrument (for example, a guitar). A musical score may be referred to as a sheet of music. The musical-score information is generated by a camera configured to capture a musical score, for example. When one of the cameras 111 to 115 generates the musical-score information, it is possible to use the camera, which generates the musical-score information, as a device configured to generate the musical-score information.

The identifier 181 identifies the student-musical-instrument information c2 based on the musical score indicated by the musical-score information. For example, the identifier 181 identifies the student-musical-instrument information c2 based on the type of musical score.

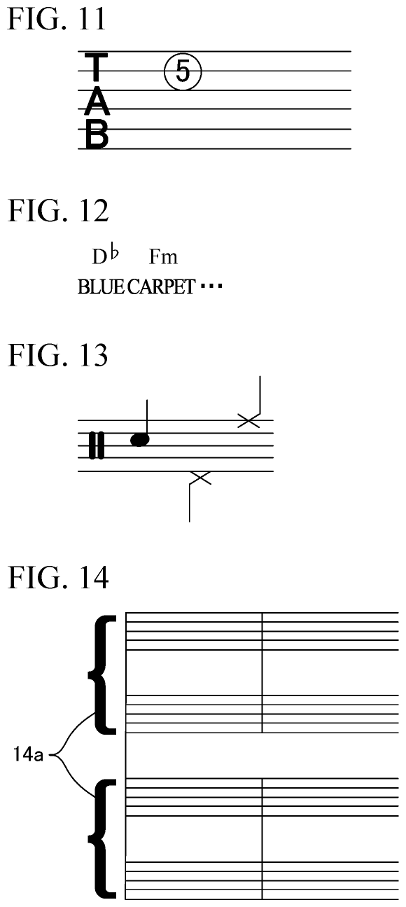

When the musical score indicated by the musical-score information is tablature, the identifier 181 identifies the student-musical-instrument information c2, which indicates a guitar as the type of musical instrument. In guitar tablature, strings are shown by six parallel lines, as shown in FIG. 11. Accordingly, when the musical score indicated by the musical-score information shows six parallel lines, the identifier 181 determines that the musical score, which is indicated by the musical-score information, is guitar tablature.

When the musical score indicated by the musical-score information is a guitar chord song chart, the identifier 181 identifies the student-musical-instrument information c2, which indicates a guitar as the type of musical 2 instrument. In a guitar chord song chart, named chords are shown along with lyrics, as shown in FIG. 12. Accordingly, when the musical score indicated by the musical-score information shows named chords, the identifier 181 determines that the musical score, which is indicated by the musical-score information, is a guitar chord song chart.

When the musical score indicated by the musical-score information is a drum score, the identifier 181 identifies the student-musical-instrument information c2, which indicates a drum kit as the type of musical instrument. In a drum score, symbols corresponding to drum types included in a drum kit are shown, as shown in FIG. 13. Accordingly, when the musical score indicated by the musical-score information shows symbols corresponding to drum types included in a drum kit, the identifier 181 determines that the musical score, which is indicated by the musical-score information, is a drum score.

When the musical score indicated by the musical-score information is a score for a duet, the identifier 181 identifies the student-musical-instrument information c2, which indicates a piano as the type of musical instrument. As shown in FIG. 14, in a score for a duet, symbols 14a indicative of a duet are shown. Accordingly, when the musical score indicated by the musical-score information shows the symbols 14a indicative of a duet, the identifier 181 determines that the musical score, which is indicated by the musical-score information, is a score for a duet.

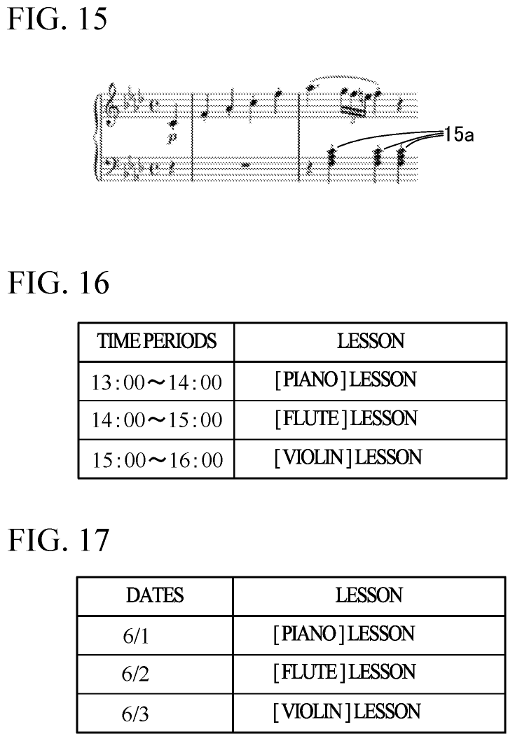

The identifier 181 may identify the student-musical-instrument information c2 based on a positional relationship between musical notes on the musical score indicated by the musical-score information. As shown in FIG. 15, when the musical score indicated by the musical-score information shows musical notation 15a indicative of simultaneous output of plural sounds, the identifier 181 determines that the musical score, which is indicated by the musical-score information, is a musical score for a keyboard instrument (for example, a piano or an electone). In this case, the identifier 181 identifies the student-musical-instrument information c2, which indicates a piano or an electone as the type of musical instrument.

When the musical score indicated by the musical-score information shows a symbol that identifies a type of musical instrument (for example, a character string representative of the name of the musical instrument, or a sign relating to the type of musical instrument), the identifier 181 may identify, as the student-musical-instrument information c2, information indicative of the type of musical instrument identified by the symbol. For example, when the storage device 170 stores a musical instrument table, which indicates associations between information indicative of the type of musical instrument and a sign relating to the type of musical instrument, the identifier 181 refers to the musical instrument table to identify, as the student-musical-instrument information c2, information (information indicative of the type of musical instrument) associated with the sign shown on the musical score. In this case, the sign relating to the type of musical instrument is an example of related information. The musical instrument table is an example of a table indicative of associations between information related to the type of musical instrument and information indicative of the type of musical instrument. The information related to the type of musical instrument is an example of reference-related information related to a musical instrument. The information indicative to the type of musical instrument is an example of reference-musical-instrument information indicative of the musical instrument.

The musical-score information is not limited to information generated by a camera configured to capture a musical score. The musical-score information may be a so-called electronic musical score. When the electronic musical score includes type data indicative of the type of musical instrument, the identifier 181 may identify the type data as the student-musical-instrument information c2.

According to the seventh modification, it is possible to use the musical-score information as the first related information related to the type of musical instrument.

### B8: Eighth Modification

In the embodiment and the first to seventh modifications described above, when schedule information, which indicates a schedule of the student 100B, also indicates the type of musical instrument, the schedule information may be used as the first related information related to the type of musical instrument. The schedule information may indicate a schedule of any one of the student 100B, the teacher 200B, the room for students provided in the music school, and the room for teachers provided in the music school, as long as the schedule information indicates a combination of the type of musical instrument and a lesson schedule for the type of musical instrument. The combination of the type of musical instrument (for example, a piano) and a lesson schedule for the type of musical instrument (for example, a piano) is an example of a combination of a musical instrument (for example, a piano) and a lesson schedule for the musical instrument (for example, a piano).

FIG. 16 is a diagram showing an example of the schedule indicated by the schedule information. In FIG. 16, for each time period of teaching (lesson), the type of musical instrument (a piano, a flute, or a violin), which is a lesson target, is indicated. The identifier 181 first refers to the schedule information to identify a time period of a lesson in which the current time is included. Then, the identifier 181 identifies the type of musical instrument that is a lesson target corresponding to the identified time period. Then, the identifier 181 identifies, as the student-musical-instrument information c2, information indicative of the type of musical instrument that is the identified lesson target.

FIG. 17 is a diagram showing another example of the schedule indicated by the schedule information. In FIG. 17, for each lesson date, the type of musical instrument, which is a lesson target, is indicated. The identifier 181 first refers to the schedule information to identify the type of musical instrument that is a lesson target corresponding to the current date. Then, the identifier 181 identifies, as the student-musical-instrument information c2, information indicative of the type of musical instrument that is the identified lesson target.

According to the eighth modification, it is possible to use the schedule information as the first related information related to the type of musical instrument.

### B9: Ninth Modification

In the embodiment and the first to eighth modifications described above, the determiner 183 may determine the target part not only based on the student-musical-instrument information c1 or c2, but also based on the student-sound information a2.

In a piano lesson, the teacher 200B often focuses on finger movements of the student 100B in a fast passage of a piece of music that is being taught. Accordingly, in a piano lesson, when the student-play sounds, which are indicated by the student-sound information a2, indicate a passage of a piece of music that immediately precedes a fast passage of the piece of music, the determiner 183 determines only fingers as the target part. Then, when the student-play sounds, which are indicated by the student-sound information a2, indicate a passage of the piece of music that immediately follows the fast passage of the piece of music, the determiner 183 determines fingers of a player, the feet of the player, and the whole body of the player, as the target parts.

In this case, the storage device 170 stores musical-score data, which indicates the passage of a piece of music that immediately precedes the fast passage of the piece of music and the passage of the piece of music that immediately follows the fast passage of the piece of music. The determiner 183 generates musical note data, which indicates the student-play sounds, based on the student-sound information a2. When the musical note data corresponds to part of the musical-score data that indicates the passage of the piece of music that immediately precedes the fast passage of the piece of music, the determiner 183 determines that the student-play sounds indicate the passage of the piece of music that immediately precedes the fast passage of the piece of music. When a degree of correspondence between the musical note data and the part of the musical-score data that indicates the passage of the piece of music that immediately precedes the fast passage of the piece of music, is greater than or equal to a first threshold (for example, 90%), the determiner 183 may determine that the student-play sounds indicate the passage of the piece of music that immediately precedes the fast passage of the piece of music. The first threshold is not limited to 90% and may be changed as appropriate. When the musical note data corresponds to part of the musical-score data that indicates the passage of the piece of music that immediately follows the fast passage of the piece of music, the determiner 183 determines that the student-play sounds indicate the passage of the piece of music that immediately follows the fast passage of the piece of music. When a degree of correspondence between the musical note data and the part of the musical-score data that indicates the passage of the piece of music that immediately follows the fast passage of the piece of music, is greater than or equal to a second threshold (for example, 90%), the determiner 183 may determine that the student-play sounds indicate the passage of the piece of music that immediately follows the fast passage of the piece of music. The second threshold is not limited to 90% and may be changed as appropriate.

With regard to a piano, timings at which the target part is changed are not limited to a timing at which the student-play sounds indicate the passage of the piece of music that immediately precedes the fast passage of the piece of music, and to a timing at which the student-play sounds indicate the passage of the piece of music that immediately follows the fast passage of the piece of music. The timings, at which the target part is changed, may be changed as appropriate. With regard to a piano, a change in the target part is not limited to the change described above and may be changed as appropriate.

For types of musical instrument different from a piano, the determiner 183 may determine the target part not only based on the student-musical-instrument information c1 or c2, but also based on the student-sound information a2.

For example, in a flute lesson, the teacher 200B often focuses on the shape of the mouth of the student 100B at a beginning of a piece of music. Accordingly, in a flute lesson, when the student-play sounds, which are indicated by the student-sound information a2, indicate the beginning of the piece of music, the determiner 183 determines only a mouth as the target part. Then, when the student-play sounds, which are indicated by the student-sound information a2, indicate a passage of the piece of music that immediately follows the beginning of the piece of music, the determiner 183 determines the mouth of a player and the upper body of the player, as the target parts.

In this case, the storage device 170 stores musical-score data, which indicates the beginning of the piece of music and the passage of the piece of music that immediately follows the beginning of the piece of music. The determiner 183 generates musical note data, which indicates the student-play sounds, based on the student-sound information a2. When the musical note data corresponds to part of the musical-score data that indicates the beginning of the piece of music, the determiner 183 determines that the student-play sounds indicate the beginning of the piece of music. When a degree of correspondence between the musical note data and the part of the musical-score data that indicates the beginning of the piece of music, is greater than or equal to a third threshold (for example, 90%), the determiner 183 may determine that the student-play sounds indicate the beginning of the piece of music. The third threshold is not limited to 90% and may be changed as appropriate. When the musical note data corresponds to part of the musical-score data that indicates the passage of the piece of music that immediately follows the beginning of the piece of music, the determiner 183 determines that the student-play sounds indicate the passage of the piece of music that immediately follows the beginning of the piece of music. When a degree of correspondence between the musical note data and the part of the musical-score data that indicates the passage of the piece of music that immediately follows the beginning of the piece of music, is greater than or equal to a fourth threshold (for example, 90%), the determiner 183 may determine that the student-play sounds indicate the passage of the piece of music that immediately follows the beginning of the piece of music. The fourth threshold is not limited to 90% and may be changed as appropriate.

With regard to a flute, timings at which the target part is changed are not limited to a timing at which the student-play sounds indicate the beginning of the piece of music, and a timing at which the student-play sounds indicates the passage of the piece of music that immediately follows the beginning of the piece of music. The timings, at which the target part is changed, may be changed as appropriate. With regard to a flute, a change in the target part is not limited to the change described above and may be changed as appropriate.

The determiner 183 may determine the target part using a trained model that has been trained to learn a relationship between first training information and second training information. The first training information includes musical instrument type information and musical instrument sound information. The musical instrument type information indicates the type of musical instrument 100A. The musical instrument sound information indicates sounds emitted from a musical instrument of the type indicated by the musical instrument type information. The second training information indicates a target part of a body of a second player. The musical instrument type information is an example of training-musical-instrument information indicative of a musical instrument. The musical instrument sound information is an example of training-sound information indicative of sounds emitted from the musical instrument indicated by the training-musical-instrument information. The first training information is an example of training-input information. The second training information indicates a part of a body of a second performer. The second performer is an example of the second player. The second performer plays a musical instrument, which belongs to the type indicated by the musical instrument type information, to emit the sounds indicated by the musical instrument sound information. The part of the body of the second performer is a target observed by a teacher of the musical instrument that belongs to the type indicated by the musical instrument type information. The second training information is an example of training-output information. The training-output information indicates a target part of a body of the second player. The second player plays the musical instrument indicated by the training-musical-instrument information. The musical instrument, which is indicated by the training-musical-instrument information, emits the sounds u indicated by the training-sound information.

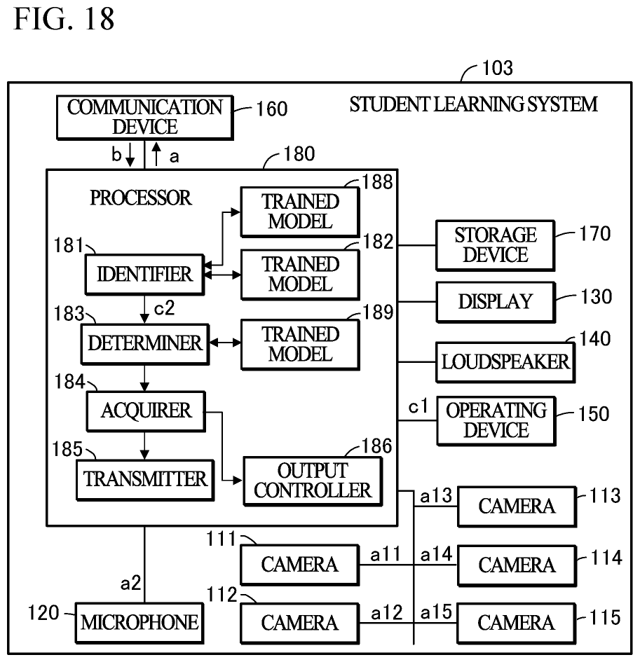

FIG. 18 is a diagram showing a student learning system 103. The student learning system 103 includes a trained model 189. The trained model 189 has been trained to learn a relationship between information, which indicates a target part, and a combination of the musical instrument type information and the musical instrument sound information. The trained model 189 is an example of a second trained model.

The trained model 189 includes a neural network. For example, the trained model 189 includes a deep neural network. The trained model 189 may include a convolutional neural network, for example. The trained model 189 may include a combination of multiple types of neural network. The trained model 189 may include additional elements such as a self-attention mechanism. The trained model 189 may include a hidden Markov model or a support vector machine, and not include a neural network.

The processor 180 functions as the trained model 189 based on a combination of an arithmetic program, which defines an operation for identifying output Y1 from input X1, and multiple variables K4. The multiple variables K4 are defined by machine learning using multiple pieces of training data T4. The training data T4 includes a combination of training input data and training output data. The training input data is a combination of the musical instrument type information and the musical instrument sound information. The training output data is target part information indicative of a target part of a body. The target part information indicates, as the target part, the part of the body of the second performer. The second performer plays a musical instrument, which belongs to the type indicated by the musical instrument type information, to emit the sounds indicated by the musical instrument sound information. The part of the body of the second performer is a target observed by a teacher of the musical instrument that belongs to the type indicated by the musical instrument type information.

The musical instrument sound information is used for each measure of a piece of music to be played. The musical instrument sound information is not limited to use for each measure. The musical instrument sound information may be used for every four measures, for example. The target part information (training output data) indicates the target part of the body of the second performer. The second performer plays a measure, which immediately follows the measure indicated by the musical instrument sound information in the 2 training input data, on the musical instrument indicated by the musical instrument type information.

The determiner 183 inputs a combination of the student-musical-instrument information c1 or c2 and the student-sound information a2 into the trained model 189 for each measure. The determiner 183 generates musical note data, which indicates the student-play sounds, based on the student-sound information a2. Then the determiner 183 identifies a measure in the student-sound information a2 based on a sequence of musical notes indicated by the musical note data. Then, the determiner 183 determines, as the target part, a part indicated by information output from the trained model 189 in response to the input of the combination of the student-musical-instrument information c or c2 and the student-sound information a2.

The multiple pieces of training data T4 may each include only the training input data and need not include the training output data. In this case, the multiple variables K4 are defined by machine learning such that the multiple pieces of training data T4 are divided into multiple clusters based on a degree of similarity between the multiple pieces of training data T4. Then, for each of the clusters, one or more persons set an association in the trained model 189. The association is an association between the cluster and information indicative of a part (target part) of a body appropriate for the cluster. The trained model 189 identifies a cluster corresponding to the input X1 and then the trained model 189 generates information corresponding to the identified cluster, as the output Y1.

According to the ninth modification, it is possible to identify imagery, which is required to teach how to play a musical instrument of the type indicated by the student-musical-instrument information c or c2, based on sounds emitted from the musical instrument.

### B10: Tenth Modification

In the ninth modification, the student learning system 100 and the teacher guiding system 200 may be used to teach how to play one type of musical instrument (for example, a piano). The one type of musical instrument is not limited to a piano and may be changed as appropriate. In this case, the determiner 183 determines the target part of the body of the player (for example, the student 100B) based on the student-sound information a2. For example, the determiner 183 inputs the student-sound information a2 for each measure into a trained model. The trained model has been trained to learn training data. The training data includes a combination of the musical instrument sound information (training input data) and the target part information (training output data) indicative of the target part of the body. In this case, the target part information (training output data), which indicates the target part of the body, indicates a part of a body of a third performer. The third performer is an example of the second player. The third performer plays a musical instrument capable of emitting the sounds indicated by the musical instrument sound information (training input data). The part of the body of the third performer is a target observed by a teacher of the musical instrument capable of emitting the sounds indicated by the musical instrument sound information (training input data). Then, the determiner 183 determines, as the target part, a part of a body indicated by information output from the trained model in response to the input of the student-sound information a2. According to the tenth modification, it is possible to identify imagery, which is required to teach how to play a musical instrument, based on sounds emitted from the musical instrument.

### B11: Eleventh Modification

In the embodiment and the first to tenth modifications described above, the determiner 183 may determine the target part of the body based on an association between the student-sound information a2 and the musical-score information indicative of the musical score of the piece of music. The association between the student-sound information a2 and the musical-score information is an example of a relationship between the student-sound information a2 and the musical-score information.

The determiner 183 determines a degree of correspondence between the sounds, which are indicated by the student-sound information a2, and sounds, which are represented in the musical score indicated by the musical-score information.

For example, in a piano lesson, when student-play sounds are improperly articulated, the teacher 200B often focuses on finger movements of the student 100B. In a piano lesson, when the degree of correspondence is less than a threshold, the determiner 183 determines only fingers of the player as the target part. When the degree of correspondence is greater than or equal to the threshold, the determiner 183 determines fingers of the player, the feet of the player, and the whole body of the player as the target parts.

In a flute lesson, when the student-play sounds are improperly articulated, the teacher 200B often focuses on the mouth of the student 100B and the upper body of the student 100B. In a flute lesson, when the degree of correspondence is less than a threshold, the determiner 183 determines the mouth of the player and the upper body of the player as the target parts. When the degree of correspondence is greater than or equal to the threshold, the determiner 183 determines the upper body of the player as the target part.

The determiner 183 may determine the target part using a trained model that has been trained to learn a relationship between third training information and fourth training information. The third training information includes the output-sound information and score-relevant information. The output-sound information indicates sounds emitted from the musical instrument 100A. The score-relevant information indicates a musical score. The fourth training information indicates a part of a body of a performer. The output-sound information is an example of training-sound information indicative of sounds emitted from a musical instrument. The score-relevant information is an example of training-musical-score information indicative of a musical score. The third training information is an example of training-input information. The fourth training information indicates a part (target part) of a body of a fourth performer. The fourth performer is an example of the second player. The fourth performer plays a musical instrument in accordance with the musical score indicated by the score-relevant information. The musical instrument is capable of emitting sounds indicated by the output-sound information. The part (target part) of the body of the fourth performer is an observed target. The fourth training information is an example of training-output information. The training-output information indicates a part of the body of the fourth performer. The fourth performer plays a musical instrument in accordance with the musical score indicated by the training-musical-score information. The musical instrument is capable of emitting sounds indicated by the training-sound information. The part of the body of the fourth performer is an observed target.

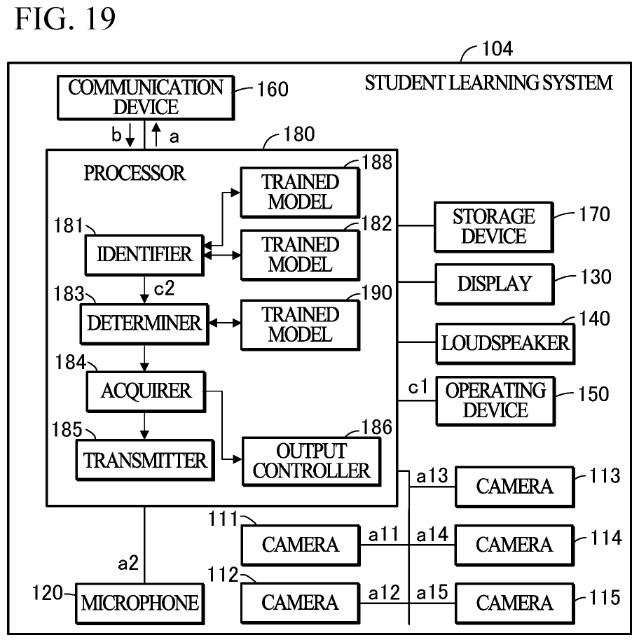

FIG. 19 is a diagram showing a student learning system 104. The student learning system 104 includes a trained model 190. The trained model 190 has been trained to learn a relationship between information, which indicate a target part of a body of a performer, and a combination of the output-sound information and the score-relevant information. The trained model 190 is an example of a third trained model.

The trained model 190 includes a neural network. For example, the trained model 190 includes a deep neural network. The trained model 190 may include a convolutional neural network, for example. The trained model 190 may include a combination of multiple types of neural network. The trained model 190 may include additional elements such as a self-attention mechanism. The trained model 190 may include a hidden Markov model or a support vector machine, and not include a neural network.

The processor 180 functions as the trained model 190 based on a combination of an arithmetic program, which defines an operation for identifying output Y1 from input X1, and multiple variables K5. The multiple variables K5 are defined by machine learning using multiple pieces of training data T5. The training data T5 includes a combination of training input data and training output data. The training input data is a combination of the output-sound information and the score-relevant information. The training output data is the target part information indicative of a target part of a body. The target part information indicates as the target part, the part of the body of the fourth performer. The fourth performer plays a musical instrument in accordance with the musical score indicated by the score-relevant information. The musical instrument is capable to emitting the sounds indicated by the output-sound information. The part of the body of the fourth performer is a target observed by a teacher of the musical instrument capable of emitting sounds indicated by the output-sound information.

The output-sound information is used for each measure of the piece of music to be played. The output-sound information is not limited to use for each measure. The output-sound information may be used for every four measures, for example. The target part information (training output data) indicates the target part of the body of the fourth performer playing a measure that immediately follows the measure indicated by the output-sound information in the training input data.

The determiner 183 inputs a combination of the student-sound information a2 and the musical-score information into the trained model 190 for each measure. The combination of the student-sound information a2 and the musical-score information is an example of input information that includes the sound information and the musical-score information. The determiner 183 generates musical note data, which indicates the student-play sounds, based on the student-sound information a2. Then the determiner 183 identifies a measure in the student-sound information a2 based on a sequence of musical notes indicated by the musical note data. Then, the determiner 183 determines, as the target part, a part indicated by information output from the trained model 190 in response to the input of the combination of the student-sound information a2 and the musical-score information.

The multiple pieces of training data T5 may include only the training input data and need not include the training output data. In this case, the multiple variables K5 are defined by machine learning such that the multiple pieces of training data T5 are divided into multiple clusters based on a degree of similarity between the multiple pieces of training data T5. Then, for each of the clusters, one or more persons set an association in the trained model 190. The association is an association between the cluster and information indicative of a part (target part) of a body appropriate for the cluster. The trained model 190 identifies a cluster corresponding to the input X1 and then the trained model 190 generates information corresponding to the identified cluster, as the output Y1.

According to the eleventh modification, it is possible to change imagery required for a lesson in accordance with an association between student-play sounds and a musical score.

### B12: Twelfth Modification

In the embodiment and the first to eleventh modifications described above, the determiner 183 of the student learning system 100 may further determine a target part of a body based on written information. The written information indicates a playing issue (attention matter). The written information may be in the form of letters or symbols. The written information is an example of information (attention information) indicative of a playing issue (attention matter regarding playing the musical instrument).

For example, the determiner 183 of the student learning system 100 determines a target part based on teacher written information. The teacher written information indicates a playing issue (attention matter) and is written on a musical score by the teacher 200B. The teacher written information is generated by any one of the cameras 11 to 115 of the teacher guiding system 200. The camera is configured to capture the part of the musical score on which the attention matter is written. The communication device 160 of the teacher guiding system 200 transmits the teacher written information to the student learning system 100. The determiner 183 of the student learning system 100 receives the teacher written information via the communication device 160 of the student learning system 100. The storage device 170 of the student learning system 100 stores an attention matter table in advance. The attention matter table indicates an association between the attention matter and a part of a body. The determiner 183 of the student learning system 100 further refers to the attention matter table to determine, as the target part, the part of the body associated with the attention matter indicated by the teacher written information.

The determiner 183 of the student learning system 100 may determine the target part based on the position of the attention matter on the musical score. In this case, the storage device 170 of the student learning system 100 stores a position table in advance. The position table indicates an association between the position of the attention matter on the musical score and a part of a body. The determiner 183 of the student learning system 100 further refers to the position table to determine, as the target part, the part of the body associated with the position of the attention matter on the musical score.

The attention matter may be written on an object (for example, a note pad, a notebook, or a whiteboard) other than the musical score.

According to the twelfth modification, it is possible to add the target part based on an attention matter written regarding playing of the musical instrument.

### B13: Thirteenth Modification

In the embodiment and the first to twelfth modifications described above, the determiner 183 of the student learning system 100 may further determine the target part of the body based on player information. The player information is, for example, identification information of the teacher 200B.

In a musical instrument lesson, the target part may be changed depending on the teacher 200B. For example, in a piano lesson, a teacher 200B1 may focus on the right arm of the student 100B in addition to fingers of the student 100B, the feet of the student 100B, and the entire body of the student 100B, whereas a teacher 200B1 may focus on the left arm of the student 100B in addition to fingers of the student 100B, the feet of the student 100B, and the entire body of the student 100B. The determiner 183 of the student learning system 100 further determines the target part based on the identification information (for example, identification code) of the teacher 200B.

The identification information of the teacher 200B is, for example, input from the operating device 150 by a user such as the student 100B. The identification information of the teacher 200B may be transmitted from the teacher guiding system 200 to the student learning system 100. The storage device 170 of the student learning system 100 stores an identification information table in advance. The identification information table indicates an association between the identification information of the teacher 200B and a part of a body. The determiner 183 of the student learning system 100 further refers to the identification information table to determine, as the target part, the part of the body associated with the identification information of the teacher 200B.

The player information is not limited to the identification information of the teacher 200B. The player information may be movement information indicative of movements of the teacher 200B. For example, one of the cameras 111 to 115 in the teacher guiding system 200 generates the movement information by capturing the teacher 200B. The communication device 160 of the teacher guiding system 200 transmits the movement information to the student learning system 100. The determiner 183 of the student learning system 100 receives the movement information via the communication device 160 of the student learning system 100. The storage device 170 of the student learning system 100 stores a movement table in advance. The movement table indicates an association between movements of a person and a part of a body. The determiner 183 of the student learning system 100 further refers to the movement table to determine, as the target part, the part of the body associated with the movements indicated by the movement information. Accordingly, the teacher 200B can designate the target part to accord with movements of the teacher 200B. The player information may be identification information of the student 100B or movement information indicative of movements of the student 100B. In this case, the determiner 183 can determine the target part in accordance with the student 100B.

According to the thirtieth modification, it is possible to add a part of a body of a player based on the player information.

### B14: Fourteenth Modification

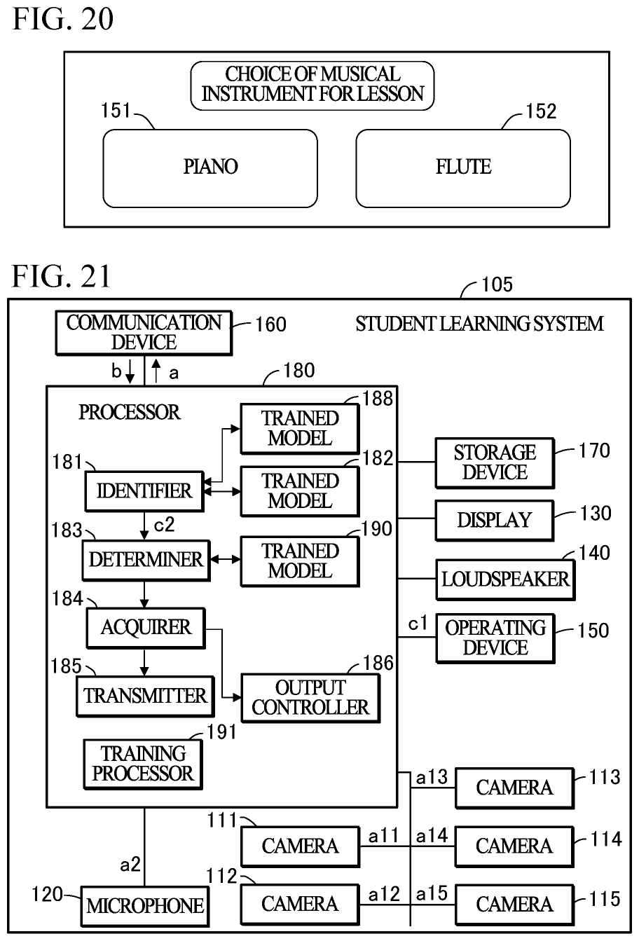

In the embodiment and the first to thirtieth modifications described above, the operating device 150, which is a touch panel, may include, as a user interface for receiving the student-musical-instrument information c1, a user interface as shown in FIG. 20. A touch on a piano button 151 causes input of the student-musical-instrument information c1 indicative of a piano as the type of musical instrument. A touch on a flute button 152 causes input of the student-musical-instrument information c1 indicative of a flute as the type of musical instrument. The user interface, which receives the student-musical-instrument information c1, is not limited to the user interface shown in FIG. 20. According to the fortieth modification, a user can easily input the student-musical-instrument information c1.

### B15: Fifteenth Modification

In the embodiment and the first to fortieth modifications described above, the communication device 160 of the teacher guiding system 200 may transmit the teacher-musical-instrument information d1 or d2 to the student learning system, and the determiner 183 of the student learning system may determine the target part based on the teacher-musical-instrument information d1 or d2. In addition, the communication device 160 of the student teaming system may transmit the student-musical-instrument information c1 or c2 to the teacher guidance system, and the determiner 183 of the teacher guidance system may determine the target part based on the student-musical-instrument information c1 or c2. The configuration of the teacher guiding system 200 may be substantially the same as the configuration of a student learning system among the student learning systems 101 to 105.

### B16: Sixteenth Modification

in the embodiment and the first to fiftieth modifications described above, the processor 180 may generate the trained model 182.

FIG. 21 is a diagram showing a student learning system 105 according to a sixtieth modification. The student learning system 105 differs from the student learning system 104 shown in FIG. 19 in that the student learning system 105 includes a training processor 191. The training processor 191 is realized by the processor 180 that executes a machine learning program. The machine learning program is stored in the storage device 170.

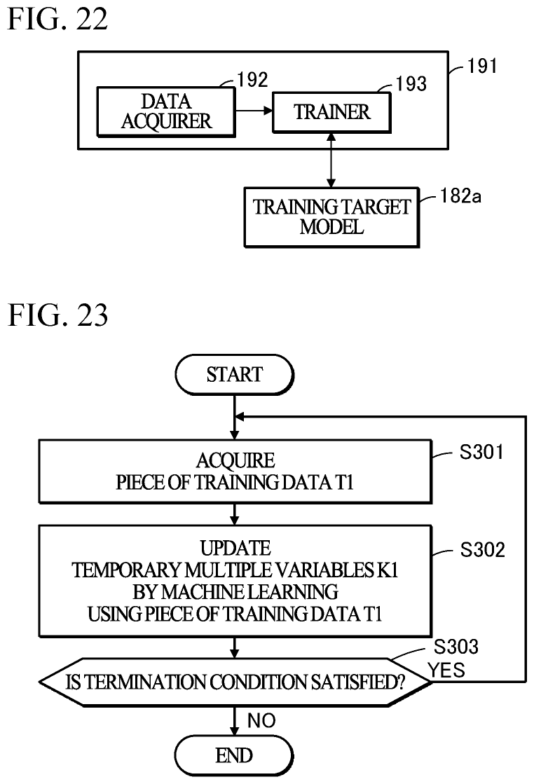

FIG. 22 is a diagram showing an example of the training processor 191. The training processor 191 includes a data acquirer 192 and a trainer 193. The data acquirer 192 acquires the multiple pieces of training data T1. For example, the data acquirer 192 acquires the multiple pieces of training data T1 via the operating device 150 or via the communication device 160. When the storage device 170 stores the multiple pieces of training data T1, the data acquirer 192 acquires the multiple pieces of training data T1 from the storage device 170.

The trainer 193 generates the trained model 182 by executing processing (hereinafter referred to as “training processing”) using the multiple pieces of training data T1. The training processing is included in supervised machine learning using the multiple pieces of training data T. The trainer 193 changes a training target model 182a into the trained model 182 by training the training target model 182a using the multiple pieces of training data T1.

The training target model 182a is generated by the processor 180 using temporary multiple variables K1 and the arithmetic program. The temporary 6) multiple variables K1 are stored in the storage device 170. The training target model 182a differs from the trained model 182 in that the training target model 182a uses the temporary multiple variables K1. The training target model 182a generates information (output data) in accordance with input information (input data).

The trainer 193 specifies a value of a loss function L. The value of the loss function L indicates a difference between first output data and second output data. The first output data is generated by the training target model 182a in response to the input data in the training data T1 being input into the training target model 182a. The second output data is the output data in the training data T1. The trainer 193 updates the temporary multiple variables K1 such that the value of the loss function L is reduced. The trainer 193 executes processing to update the temporary multiple variables K1 for each of the multiple pieces of training data T1. Upon completion of the training by the trainer 193, the multiple variables K1 are fixed. The training target model 182a has been trained by the trainer 193. In other words, the trained model 182 outputs output data statistically appropriate for input data.

FIG. 23 is a diagram showing an example of the training processing. For example, the training processing starts in response to an instruction from a user.

At step S301, the data acquirer 192 acquires a piece of training data T1, which has not been acquired, from among the multiple pieces of training data T1. At step S302, the trainer 193 trains the training target model 182a using the piece of training data T1. At step S302, the trainer 193 updates the temporary multiple variables K1 such that the value of the loss function L specified by using the piece of training data T1 is reduced. For the processing to update the temporary multiple variables K1 in accordance with the value of the loss function L, for example, a backpropagation method is used.

At step S303, the trainer 193 determines whether a termination condition related to the training processing is satisfied. The termination condition is, for example, a condition, in which a value of the loss function L is less than a predetermined threshold, or a condition, in which an amount of change in the value of the loss function L is less than a predetermined threshold. When the termination condition is not satisfied, the processing returns to step S301. Accordingly, the acquisition of a piece of training data T1 and the updating of the temporary multiple variables K1 using the piece of training data T1 are repeated until the termination condition is satisfied. When the termination condition is satisfied, the training processing terminates.

The training processor 191 may be realized by a processor different from the processor 180. The processor different from the processor 180 includes at least one computer.

The data acquirer 192 may acquire multiple pieces of training data, which are different from the multiple pieces of training data T1. For example, the data acquirer 192 may acquire one or more types of multiple pieces of training data from among four types of multiple pieces of training data. The four types of multiple pieces of training data include multiple pieces of training data T2, T3, T4, and T5. The trainer 193 trains a training target model corresponding to the type of multiple pieces of training data acquired by the data acquirer 192. The training target model corresponding to the multiple pieces of training data T2 is a training target model generated by the processor 180 using temporary multiple variables K2 and the arithmetic program. The training target model corresponding to the multiple pieces of training data T3 is a training target model generated by the processor 180 using temporary multiple variables K3 and the arithmetic program. The training target model corresponding to the multiple pieces of training data T4 is a training target model generated by the processor 180 using temporary multiple variables K4 and the arithmetic program. The training target model corresponding to the multiple pieces of training data T5 is a training target model generated by the processor 180 using temporary multiple variables K5 and the arithmetic program.

The data acquirer 192 may be provided for each of the types of multiple pieces of training data. In this case, each data acquirer 192 acquires the corresponding multiple pieces of training data.

The trainer 193 may be provided for each of the types of multiple pieces of training data. In this case, each trainer 193 uses the corresponding multiple pieces of training data to train a training target model corresponding to the corresponding multiple pieces of training data.

According to the sixtieth modification, the training processor 191 can generate at least one trained model.

### B17: Seventeenth Modification

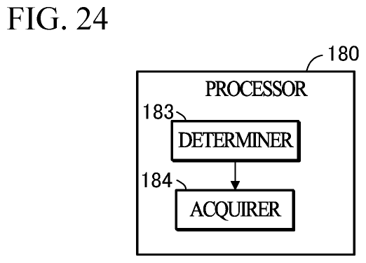

In the embodiment and the first to sixtieth modifications described above, the processor 180 may function only as the determiner 183 and the acquirer 184, as shown in FIG. 24. The determiner 183 shown in FIG. 24 determines, based on musical instrument information indicative of a type of musical instrument, a target part of a body of a player of a musical instrument of the type indicated by the musical instrument information. The acquirer 184 shown in FIG. 24 acquires image information indicative of imagery of the target part determined by the determiner 183. According to the seventieth modification, it is possible to identify imagery of a player, which is required to teach how to play a musical instrument, in accordance with the type of musical instrument.

### B18: Eighteenth Modification

In the seventieth modification, the determiner 183 shown in FIG. 24 may determine, based on sound information indicative of sounds emitted from a musical instrument, not based on the musical instrument information indicative of a type of musical instrument, the target part of a body of a player of the musical instrument. In addition, in the seventieth modification, the acquirer 184 shown in FIG. 24 may acquire image information indicative of imagery of the target part determined by the determiner 183 based on the sound information indicative of the sounds emitted from the musical instrument. According to the eightieth modification, it is possible to identify imagery of a player, which is required to teach how to play a musical instrument, in accordance with sounds emitted from the musical instrument.

### C: Aspects Derivable from the Embodiment and the Modifications Described Above

The following configurations are derivable from at least one of the embodiment and the modifications described above.

### C1: First Aspect

An information processing method according to one aspect (first aspect) of the present disclosure is a computer-implemented information processing method that includes: determining, based on musical instrument information indicative of a musical instrument, a target part of a body of a first player, the first player playing the musical instrument indicated by the musical instrument information; and acquiring image information indicative of imagery of the determined target part. According to this aspect, it is possible to identify imagery of a player, which is required to teach how to play a musical instrument, in accordance with the musical instrument.

### C2: Second Aspect

In an example (second aspect) of the first aspect, the information processing method further includes transmitting the acquired image information to an external apparatus. According to this aspect, it is possible to transmit imagery of a player, which is required to teach how to play a musical instrument, to an external apparatus.

### C3: Third Aspect

In an example (third aspect) of the first aspect or the second aspect, the information processing method further includes identifying the musical instrument information by using related information related to the musical instrument. The determining the target part includes determining the target part based on the identified musical instrument information. According to this aspect, it is possible to identify imagery of a player, which is required to teach how to play a musical instrument, based on related information related to a musical instrument.

### C4: Fourth Aspect

In an example (fourth aspect) of the third aspect, the related information includes: information indicative of sounds emitted from the musical instrument; information indicative of imagery of the musical instrument; information indicative of a musical score for the musical instrument; or information indicative of a combination of the musical instrument and a lesson schedule for the musical instrument. According to this aspect, it is possible to use various kinds of information as related information.

### C5: Fifth Aspect

In an example (fifth aspect) of the third aspect or the fourth aspect, the identifying the musical instrument information includes: inputting the related information into a first trained model, the first trained model having been trained to learn a relationship between training-related information and training-musical-instrument information, the training-related information being related to the musical instrument, and the training-musical-instrument information being indicative of a musical instrument specified from the training-related information; and identifying, as the musical instrument information, information output from the first trained model in response to the related information. According to this aspect, the musical instrument information is identified by using a trained model. Therefore, the musical instrument information can indicate a musical instrument, which is played by a player, with high accuracy.

### C6: Sixth Aspect

In an example (sixth aspect) of the fifth aspect, the related information and the training-related information each indicates sounds emitted from the musical instrument; and the training-musical-instrument information indicates, as the musical instrument specified from the training-related information, a musical instrument that emits the sounds indicated by the training-related information. According to this aspect, it is possible to identify a musical instrument based on sounds emitted from the musical instrument.

### C7: Seventh Aspect

In an example (seventh aspect) of the fifth aspect, the related information and the training-related information each indicates imagery of the musical instrument; and the training-musical-instrument information indicates, as the musical instrument specified from the training-related information, a musical instrument represented by the imagery indicated by the training-related information. According to this aspect, it is possible to identify a musical instrument based on imagery of the musical instrument.

### C8: Eighth Aspect

In an example (eighth aspect) of the third aspect, the identifying the musical instrument information includes identifying, as the musical instrument information, reference-musical-instrument information associated with the related information by referring to a table indicative of associations between reference-related information related to the musical instrument and the reference-musical-instrument information indicative of the musical instrument. According to this aspect, it is possible to identify musical instrument information without using a trained model.

### C9: Ninth Aspect

In an example (ninth aspect) of any one of the first to eighth aspects, the determining the target part includes determining the target part based on the musical instrument information and sound information, the sound information being indicative of sounds emitted from the musical instrument indicated by the musical instrument information. According to this aspect, it is possible to identify imagery of a player, which is required to teach how to play a musical instrument, based on sounds emitted from the musical instrument.

### C10: Tenth Aspect

In an example (tenth aspect) of the ninth aspect, the determining the target part includes: inputting input information into a second trained model, the input information including the musical instrument information and the sound information, the second trained model having been trained to learn a relationship between training-input information and training-output information, the training-input information including training-musical-instrument information and training-sound information, the training-musical-instrument information being indicative of the musical instrument, the training-sound information being indicative of sounds emitted from the musical instrument indicated by the training-musical-instrument information, the training-output information being indicative of a target part of a body of a second player, the second player playing the musical instrument indicated by the training-musical-instrument information, and the musical instrument indicated by the training-musical-instrument information emitting the sounds indicated by the training-sound information; and determining the target part based on output information output from the second trained model in response to the input information. According to this aspect, the target part is identified by using the trained model. Therefore, it is possible to identify, based on sounds emitted from a musical instrument, imagery of a player, which is required to teach how to play the musical instrument, with high accuracy.

### C11: Eleventh Aspect

An information processing method according to another aspect (first aspect) of the present disclosure is a computer-implemented information processing method that includes: determining, based on sound information indicative of sounds emitted from a musical instrument, a target part of a body of a first player, the first player playing the musical instrument; and acquiring image information indicative of imagery of the determined target part. According to this aspect, it is possible to identify imagery of a player, which is required to teach how to play a musical instrument, in accordance with sounds emitted from the musical instrument.

### C12: Twelfth Aspect

In an example (twelfth aspect) of the ninth aspect or the eleventh aspect, the determining the target part includes determining the target part based on a relationship between the sound information and musical-score information indicative of a musical score. According to this aspect, it is possible to identify imagery of a player, which is required to teach how to play a musical instrument, based on the relationship between the musical-score information and the sound information.

### C13: Thirteenth Aspect

In an example (thirtieth aspect) of the eleventh aspect, the determining the target part includes: inputting input information into a third trained model, the input information including the sound information and musical-score information, the musical-score information being indicative of a musical score, the third trained model having been trained to learn a relationship between training-input information and training-output information, the training-input information including training-sound information and training-musical-score information, the training-sound information being indicative of sounds emitted from the musical instrument, the training-musical-score information being indicative of a musical score, the training-output information being indicative of a target part of a body of a second player, the second player playing the musical instrument in accordance with the musical score indicated by the training-musical-score information, and the musical instrument being capable of emitting the sounds indicated by the training-sound information; and determining the target part based on output information output from the third trained model in response to the input information. According to this aspect, the target part is identified by using the trained model. Therefore, it is possible to identify imagery of a player, which is required to teach how to play the musical instrument, with high accuracy.

### C14: Fourteenth Aspect

In an example (fortieth aspect) of any one of the first to thirtieth aspects, the determining the target part includes determining the target part based on attention information indicative of an attention matter regarding playing the musical instrument. According to this aspect, it is possible to change imagery of a player, which is required to teach how to play a musical instrument, in accordance with an attention matter regarding playing the musical instrument.

### C15: Fifteenth Aspect

In an example (fiftieth aspect) of any one of the first to fortieth aspects, the determining the target part includes determining the target part based on player information regarding the first player. According to this aspect, it is possible to change imagery of a player, which is required to teach how to play a musical instrument, in accordance with player information regarding the player.

### C16: Sixteenth Aspect

An information processing system according to yet another aspect (sixtieth aspect) of the present disclosure includes: at least one memory configured to store instructions; and at least one processor configured to implement the instructions to: determine, based on musical instrument information indicative of a musical instrument, a target part of a body of a first player, the first player playing the musical instrument indicated by the musical instrument information; and acquire image information indicative of imagery of the determined target part. According to this aspect, it is possible to identify imagery of a player, which is required to teach how to play a musical instrument, in accordance with the musical instrument.

### C17: Seventeenth Aspect

An information processing system according to yet another aspect (seventieth aspect) of the present disclosure includes: at least one memory configured to store instructions; and at least one processor configured to implement the instructions to: determine, based on sound information indicative of sounds emitted from a musical instrument, a target part of a body of a first player, the first player playing the musical instrument; and acquire image information indicative of imagery of the determined target part. According to this aspect, it is possible to identify imagery of a player, which is required to teach how to play a musical instrument, in accordance with sounds emitted from the musical instrument.

### DESCRIPTION OF REFERENCE SIGNS

1 . . . information providing system, 100 . . . student learning system, 100A . . . musical instrument, 100B . . . student, 111 to 115 . . . camera, 120 . . . microphone, 130 . . . display, 140 . . . loudspeaker, 150 . . . operating device, 160 . . . communication device, 170 . . . storage device, 180 . . . processor, 181 . . . identifier, 182 . . . trained model, 182a . . . training target model, 183 . . . determiner, 184 . . . acquirer, 185 . . . transmitter, 186 . . . output controller, 187 to 190 . . . trained model, 191 . . . training processor, 192 . . . data acquirer, 193 . . . trainer, 200 . . . teacher guiding system, 200A . . . musical instrument, 200B . . . teacher.

What is claimed is:

1. A computer-implemented information processing method comprising:
determining, based on musical instrument information indicative of a musical instrument, a target part of a body of a first player, the first player playing the musical instrument indicated by the musical instrument information; and
acquiring image information indicative of imagery of the determined target part.

2. The information processing method according to claim 1, further comprising transmitting the acquired image information to an external apparatus.

3. The information processing method according to claim 1,
further comprising identifying the musical instrument information by using related information related to the musical instrument,
wherein the determining the target part includes determining the target part based on the identified musical instrument information.

4. The information processing method according to claim 3, wherein the related information includes at least one of:
information indicative of sounds emitted from the musical instrument;
information indicative of imagery of the musical instrument;
information indicative of a musical score for the musical instrument; or
information indicative of a combination of the musical instrument and a lesson schedule for the musical instrument.

5. The information processing method according to claim 3, wherein identifying the musical instrument information includes:
inputting the related information into a trained model, the trained model having been trained to learn a relationship between training-related information and training-musical-instrument information, the training-related information being related to the musical instrument, and the training-musical-instrument information being indicative of a musical instrument specified from the training-related information; and
identifying, as the musical instrument information, information output from the trained model in response to the related information.

6. The information processing method according to claim 5, wherein:
the related information and the training-related information each indicates sounds emitted from the musical instrument; and
the training-musical-instrument information indicates, as the musical instrument specified from the training-related information, a musical instrument that emits the sounds indicated by the training-related information.

7. The information processing method according to claim 5, wherein:
the related information and the training-related information each indicates imagery of the musical instrument, and
the training-musical-instrument information indicates, as the musical instrument specified from the training-related information, a musical instrument represented by the imagery indicated by the training-related information.

8. The information processing method according to claim 3, wherein identifying the musical instrument information includes identifying, as the musical instrument information, reference-musical-instrument information associated with the related information by referring to a table indicative of associations between reference-related information related to the musical instrument and the reference-musical-instrument information indicative of the musical instrument.

9. The information processing method according to claim 1, wherein determining the target part includes determining the target part based on the musical instrument information and sound information, the sound information being indicative of sounds emitted from the musical instrument indicated by the musical instrument information.

10. The information processing method according to claim 9, wherein determining the target part includes:
inputting input information into a trained model, the input information including the musical instrument information and the sound information, the trained model having been trained to learn a relationship between training-input information and training-output information, the training-input information including training-musical-instrument information and training-sound information, the training-musical-instrument information being indicative of the musical instrument, the training-sound information being indicative of sounds emitted from the musical instrument indicated by the training-musical-instrument information, the training-output information being indicative of a target part of a body of a second player, the second player playing the musical instrument indicated by the training-musical-instrument information, and the musical instrument indicated by the training-musical-instrument information emitting the sounds indicated by the training-sound information; and
determining the target part based on output information output from the trained model in response to the input information.

11. A computer-implemented information processing method comprising:
determining, based on sound information indicative of sounds emitted from a musical instrument, a target part of a body of a first player, the first player playing the musical instrument; and
acquiring image information indicative of imagery of the determined target part.

12. The information processing method according to claim 11, wherein determining the target part includes determining the target part based on a relationship between the sound information and musical-score information indicative of a musical score.

13. The information processing method according to claim 11, wherein determining the target part includes:
inputting input information into a trained model, the input information including the sound information and musical-score information, the musical-score information being indicative of a musical score, the trained model having been trained to learn a relationship between training-input information and training-output information, the training-input information including training-sound information and training-musical-score information, the training-sound information being indicative of sounds emitted from the musical instrument, the training-musical-score information being indicative of a musical score, the training-output information being indicative of a target part of a body of a second player, the second player playing the musical instrument in accordance with the musical score indicated by the training-musical-score information, and the musical instrument being capable of emitting the sounds indicated by the training-sound information; and
determining the target part based on output information output from the trained model in response to the input information.

14. The information processing method according to claim 1, wherein determining the target part includes determining the target part based on attention information indicative of an attention matter regarding playing the musical instrument.

15. The information processing method according to claim 1, wherein determining the target part includes determining the target part based on player information regarding the first player.

16. An information processing system comprising:
at least one memory configured to store instructions; and
at least one processor configured to execute the instructions to:
determine, based on musical instrument information indicative of a musical instrument, a target part of a body of a first player, the first player playing the musical instrument indicated by the musical instrument information; and
acquire image information indicative of imagery of the determined target part.
